(19) United States
(12) Patent Application Publication
(10) Pub. No.: US 2024/0365361 A1
(43) Pub. Date: Oct. 31, 2024

(54) SIDELINK MODE 1 ENHANCED RESOURCE ALLOCATION FOR DIRECTIONAL TRANSMISSIONS

(71) Applicant: InterDigital Patent Holdings, Inc., Wilmington, DE (US)

(72) Inventors: Umer SALIM, Vallauris (FR); Sanjay GOYAL, Deer Park, NY (US); Ravikumar PRAGADA, Warrington, PA (US)

(21) Appl. No.: 18/687,580

(22) PCT Filed: Aug. 23, 2022
(86) PCT No.: PCT/US2022/041209

§ 371 Date: Feb. 28, 2024

Related U.S. Application Data
(60) Provisional application No. 63/274,366, filed on Nov. 1, 2021.
(60) Provisional application No. 63/238,963, filed on Aug. 31, 2021.

(51) Int. Cl. H04W 72/541; H04L 5/00; H04W 72/40; H04W 92/18

(52) U.S. Cl. CPC H04W 72/541; H04L 5/0055; H04L 5/0094; H04W 72/40; H04W 92/18

(57) ABSTRACT

A method performed by a transmitting, Tx, WTRU performing sidelink, SL, communications with a receiving, Rx, WTRU, includes sending a periodic SL resource allocation request to a base station, BS, including directional information comprising a direction of transmission to the Rx WTRU, receiving configuration information of multiple sets of periodic time-frequency, T-F, resources for SL communication with the Rx WTRU, the configuration information including an indication of a first set of the multiple sets of T-F resources to use for SL communication with the Rx WTRU, and transmitting on SL to the Rx WTRU using the first set of T-F resources using the direction of transmission to the Rx WTRU.

### CROSS REFERENCE TO RELATED APPLICATIONS

This application claims the benefit of U.S. provisional patent application No. 63/238,963 filed 31 Aug. 2021 and U.S. provisional application No. 63/274,366 filed 1 Nov. 2021 which are incorporated by reference herein in their entirety.

### BACKGROUND

Direct device to device communication in 5G new radio networks for vehicle to vehicle communication may include features such as vehicle platooning, advanced driving, the use of extended sensors, and remote driving. Any particular device to device communication pair, from one vehicle to another vehicle, may be subject to interference from an external source. One external source may be another device to device pair operating in the same general location wherein a transmission for one pair interferes with another device to device pair. Since such mutual interference is very undesirable, steps should be taken in system design to avoid interference from between reasonably proximate device pairs.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. TA;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. TA;

FIG. 2 depicts a gNB allocating SL time frequency (T-F) Resource ‘x’ to a single SL Tx in the cell to avoid collisions;

FIG. 3 depicts a gNB having limited position/directionality information and allocating T-F resource ‘x’ to 2 SL Txs;

FIG. 4 depicts a gNB having position/directional knowledge and aggressive allocation of SL T-F resource ‘x’;

FIG. 5 depicts SL configured grant (CG) in Mode 1 with SL Transmission Direction Indication;

FIG. 6 depicts a direction update indicates smooth co-existence of SL Tx-Rx pairs;

FIG. 7 depicts a direction update that shows interference risk and the gNB changes T-F CG configuration;

FIG. 8 depicts a multiple configurations and fast DCI based activation of appropriate configuration;

FIG. 9 depicts a Flow Diagram with SL Rx Indication for the gNB according to aspects of the disclosure;

FIG. 10 depicts a gNB tracking the SL Rx, and if interference risk among SL device, updates the CG resources;

FIG. 11 depicts a multiple configurations and activation of a suitable configuration;

FIG. 12 depicts a Direction Specific SL Periodic Resource Configuration;

FIG. 13 depicts a change in cone of operation;

FIG. 14 depicts a change in cone of operation leading to update in an active resource set;

FIG. 15 depicts an example method flow diagram according to the disclosure;

FIG. 16 depicts a Tx WTRU sending information to a base station for a dynamic grant;

FIG. 17 depicts a message diagram example of direction specific scheduling request resource configuration;

FIG. 18 depicts an example method flow diagram according to the disclosure;

FIG. 19 depicts a signal diagram having multiple aspects of the disclosure;

FIG. 20A depicts a flow diagram having an aspect of the disclosure;

FIG. 20B depicts a flow diagram having another aspect of the disclosure;

FIG. 20C depicts a flow diagram having an activation of T-F resource according to an aspect of the disclosure; and

FIG. 20D depicts a flow diagram having a HARQ-NACK response according to the disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

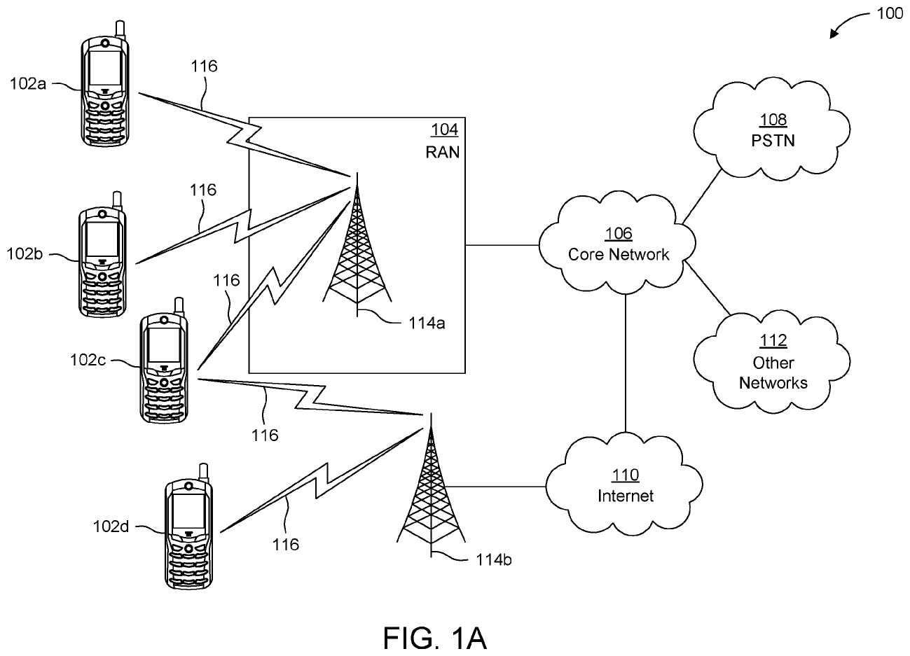

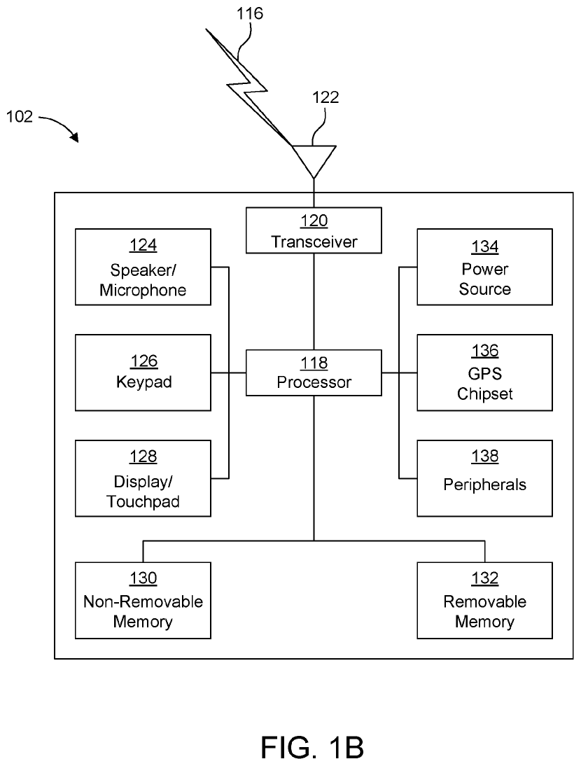

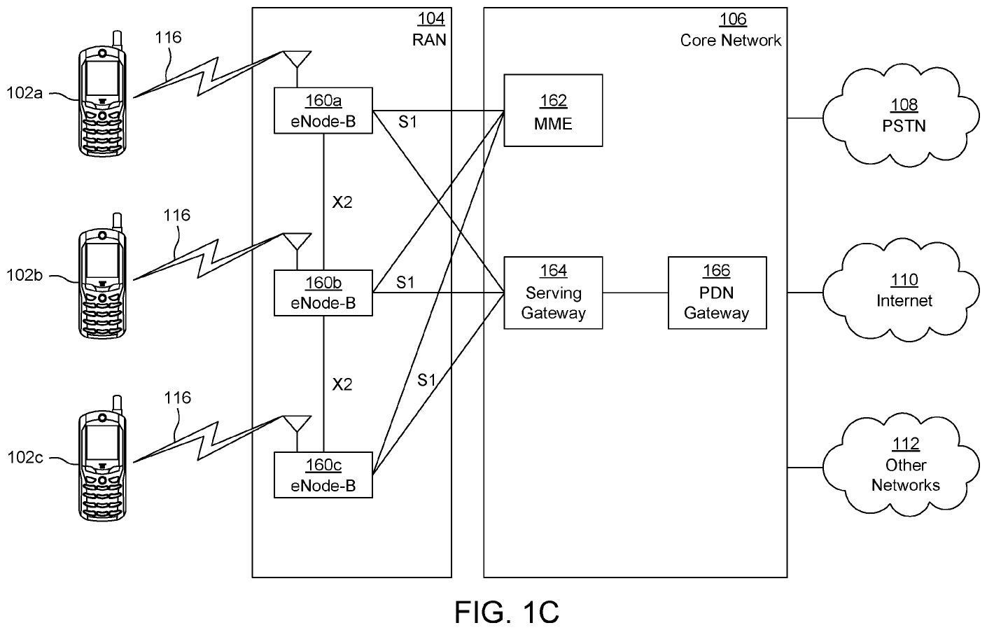

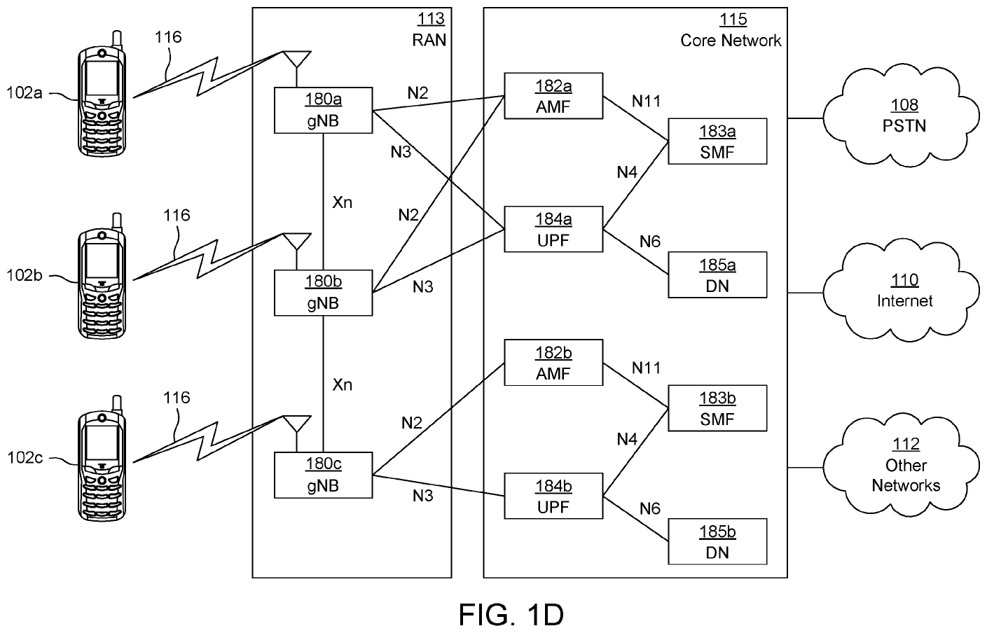

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. TA, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. TA, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b. 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the Si interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n. 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In anon-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a. 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro. and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a. 184b and an N6 interface between the UPF 184a. 184b and the DN 185a, 185b.

In view of FIGS. 1A-1D, and the corresponding description of FIGS. 1A-1D, one or more, or all, of the functions described herein with regard to any of WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Device to Device (D2D) Communication

Device-to-Device (D2D) communication has been a center of attraction for a long time in wireless communications. The Third Generation Partnership Program (3GPP) standardized the first version of D2D communication in Release-12 for proximity services. Later in Release-14, 3GPP standardized Long Term evolution (LTE) Vehicle to Everything (V2X) based on the 4G LTE cellular standard. This underwent further feature enhancements within 3GPP Release-15.

In parallel, 3GPP standardized the baseline for 5G cellular standard new radio (NR). 5G NR has been standardized with a very flexible and forward-looking design. 5GNR comes with plenty of advanced functionalities like flexible numerologies, advanced design for the control transmission, bandwidth part, configurability of transmission and Hybrid Automatic Repeat-Request (HARQ) related parameters etc. This then led to the standardization of first sidelink (SL) standard in 3GPP Release-16, so called NR Sidelink, which has been designed with the NR foundations. Sidelink here refers to the direct data communication between the devices without data passing through the network. The resource allocation in sidelink though has different features which enable the efficient sidelink operation for the devices which are in-coverage of a cell or when the devices are out of coverage.

### Motivation of NR Sidelink in Release-16 and Release-17 Enhancements

3GPP technical report (TR) 22.886 and TS 22.186 present a comprehensive description of the NR V2X use cases and requirements, respectively which become the basis for NR SL work in Rel-16. The use cases are divided in the following four groups:
1) Vehicles Platooning: This group includes use cases for the dynamic formation and management of groups of vehicles in platoons. Vehicles in a platoon exchange data periodically to ensure the correct functioning of the platoon. The inter-vehicle distance between vehicles in a platoon may depend on the available Quality of Service (QoS).
2) Advanced Driving: This group includes use cases enabling semi-automated or fully-automated driving. In this group, vehicles share data obtained from their local sensors with surrounding vehicles in proximity. In addition, vehicles share their driving intention in order to coordinate their trajectories or maneuvers, thus increasing safety and improving traffic efficiency.
3) Extended Sensors: This group enables the exchange of sensor data—either raw or processed—collected through local sensors between vehicles, Roadside Units (RSUs), devices of pedestrians, and V2X application servers. The objective is to improve the perception of the environment beyond the perception capabilities of the vehicles' own sensors.
4) Remote Driving: This group enables a remote (tele-operated) driver or a V2X application to operate a vehicle. The main use cases are for passengers who cannot drive themselves, for vehicles located in hazardous environments (e.g., construction areas or locations with adverse weather conditions), and for complex situations which automated vehicles are unable to drive safely.

The physical layer structure for the NR V2X SL is based on the Rel. 15 NR Uu reference interface design. In addition, the physical layer procedures for the NR V2X SL reuses some of the concepts of Rel. 14 LTE V2X, with the introduction of additional procedures for providing physical layer support for unicast and groupcast transmissions. Although both frequency ranges are supported in NR V2X sidelink, the design of NR V2X sidelink has been based mainly on frequency range 1 (FR1). For NR V2X sidelink, no specific optimization is performed for FR2, except for addressing phase noise which is more prominent at higher frequencies.

Transmissions in NR V2X SL use the orthogonal frequency division multiplexing (OFDM) waveform with a cyclic prefix (CP). The sidelink frame structure is organized in radio frames (also referred simply as frames), each with a duration of 10 ms. A radio frame is divided into 10 subframes, each with a duration of 1 ms. This physical structure is basically aligned with 5G NR Uu structure standardized in Rel-15.

### Mode 1 Sidelink Resource Allocation

3GPP Release-16 has provided two designs for sidelink resource allocation. For the devices in-coverage of a cell, SL resource allocation can be done by the base station (e.g. gNB), which is called Mode 1 based resource allocation. SL devices can perform autonomous resource allocation based upon sensing the resources themselves which have been made available for SL communication. This autonomous mode of SL resource allocation is called Mode 2 resource allocation. In Mode 2, the SL devices perform sidelink resource allocation for their transmissions in an autonomous manner.

The gNB performs the SL resource allocation in Mode 1. Thus, the devices performing under Mode 1 resource allocation must be in network coverage. SL radio resources can be allocated from licensed carriers dedicated to SL communications or from licensed carriers that share resources between SL and UL communications. The SL radio resources can be configured so that mode 1 and mode 2 use separate resource pools. The alternative is that mode 1 and mode 2 share the resource pool. Pool sharing can result in a more efficient use of the resources, but it is prone to potential collisions between mode 1 and mode 2 transmissions. To solve this, mode 1 UEs (Mode 1 WTRUs) notify mode 2 UEs (Mode 2 WTRUs) of the resources allocated for their future transmissions as it is described below.

Mode 1 uses dynamic grant (DG) scheduling like LTE V2X mode 3 but replaces the semi-persistent scheduling in LTE V2X mode 3 with a configured grant scheduling. With DG, mode 1 WTRUs must request resources from the base station for the transmission of every single transport block (TB) (including its blind or HARQ based retransmissions). To this aim, the WTRUs must send a Scheduling Request (SR) to the gNB using the physical uplink control channel (PUCCH), and the gNB responds with the downlink control information (DCI) over the physical downlink control channel (PDCCH). The DCI indicates the SL resources (i.e., the slot(s) and sub-channel(s)) allocated for the transmission of a TB and up to 2 possible retransmissions of this TB. The WTRU informs other WTRUs about the resources it will use to transmit a TB and up to 2 possible retransmissions using the 1st-stage sidelink control information (SCI).

Nearby WTRUs operating under mode 2 can then know which resources WTRUs in mode 1 will utilize. Requesting resources for each TB increases the delay. Mode 1 includes the configured grant scheduling option to reduce the delay by pre-allocating SL radio resources. With this scheme, the gNB can assign a set of SL resources to a WTRU for transmitting several TBs. This set is referred to as a configured grant (CG). The WTRU sends first a message with WTRU assistance information to the gNB indicating information about the expected SL traffic including: periodicity of TBs, TB maximum size, and QoS information. The QoS information includes key performance indicators (KPIs) such as the latency and reliability required by the TBs and their priority. This information is used by the gNB to create, configure and allocate a CG to the WTRU that satisfies the requirements of the SL traffic. The CG is configured using a set of parameters that includes the CG index, the time-frequency (T-F) allocation, and the periodicity of the allocated SL resources. The time-frequency allocation indicates the slot(s) and sub-channel(s) that are assigned periodically to the WTRU in a CG.

A WTRU can be assigned a maximum of 3 SL resources during each period of the CG. The WTRU informs other vehicles of the resources allocated by the gNB for a particular CG period using again the 1st-stage SCI. The WTRU can decide how to use the SL resources of an assigned CG. However, it can only transmit one new TB in each CG period. The SL resources of a CG period can also be used to retransmit the new TB transmitted in this CG, or to retransmit other TBs initially transmitted in previous CG periods. The maximum number of retransmissions per TB in a CG is associated with the priority of the TB. HARQ based retransmissions in a CG are only possible if the resource pool of the CG has a physical sidelink feedback channel (PSFCH) configured by the gNB. It should be noted that a gNB can assign multiple SL CGs to a WTRU. The configuration of each CG can be adapted to the characteristics or demands of different V2X applications. However, the transmission and retransmissions of a TB must always utilize resources of a single CG.

Mode 1 defines two types of CG schemes for SL: CG type 1 and CG type 2. Both are configured using Radio Resource Control (RRC) signaling. CG type 1 can be utilized by the WTRU immediately until it is released by the gNB base station (also using RRC signaling). SL CG type 2 can be used only after it is activated by the gNB and until it is deactivated. To this aim, the gNB notifies of the activation and deactivation using DCI signaling. The DCI also includes the CG index and time-frequency allocation of CG type 2. CG type 2 can configure multiple CGs for a WTRU and only activate a subset of the CGs based on the WTRU needs. Resources in non-active CGs can be allocated to other WTRUs. CG type 1 can also configure multiples CGs. However, it forces WTRUs to activate CGs at the time of their configuration. CG type 1 reduces the signaling and the time needed to initiate a transmission compared to CG type 2. However, if any of the CGs type 1 are not used by the WTRU, the resources cannot be allocated to other WTRUs.

### Issues Concerning Mode 1 Based SL Resource Allocation

For very high frequency carriers, omni-directional transmission and reception are not practical from physical antenna constraints and it may result in significant coverage loss. If legacy designed resource allocation procedures are projected to very high frequency carriers which may require beamformed communications, the strong directionality associated with the Tx and Rx beams results in significant performance degradation because the resource allocations were designed primarily for omni-directional transmissions.

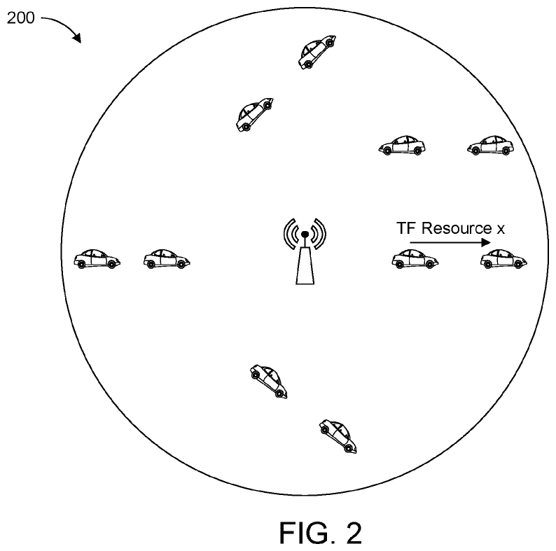

In the examples hereinbelow, a gNB is used as an example of a base station. Examples provided below apply equally well to different implementations of base stations even when the term gNB is used for example purposes. This disclosure herein discusses the in-coverage scenarios where the base station, such as gNB, is performing the SL resource allocation for SL devices. Typically, the gNB will allocate a given time frequency resource or sub-channel to one SL device, and refrain from allocating the same resource to neighboring devices so that there are no collisions on that resource. Given the fact that the transmissions are highly directional for the high frequency carriers, the classic scheduling will result in very poor system efficiency. FIG. 2 depicts WTRUs in a cell having various locations and directions compared to a gNB. In this typical configuration, only one time-frequency (T-F) resource (labeled “x”) may be safely allocated for D2D communication between pairs of SL WTRUs. The “x” resource may not be safely allocated by the gNB within the cell to other WTRU D2D communication pairs (SL pairs) in order to avoid collisions in either time or frequency use within the cell. As used herein, the term “SL Tx” refers to a sidelink transmitting WTRU and the term “SL Rx” refers to a sidelink receiving WTRU.

Due to large number of devices and the inherent directionality for high frequency systems, efficient solutions need to be enabled through some useful information provisioning. The description herein proposes novel solutions for Mode 1 based SL resource allocation which allow aggressive time-frequency resource allocation resulting in significant system performance improvement.

### Solutions—Aggressive Time-Frequency (T-F) Resource Allocation for SL Mode 1

In SL Mode 1 resource allocation, the gNB acts to allocate the resources to SL users for their SL transmissions. For configured grant-based SL transmissions in Mode 1, the gNB allocates periodic resources to SL users for their SL transmissions. The first three embodiments in this disclosure, entitled Aggressive Time-Frequency Resource Allocation for Configured Grants with Direction Information and Updates, Aggressive T-F Resource Allocation for Configured Grants with SL Rx Indication, and Aggressive T-F Resource Allocation for CG with Direction Specific Resource Set Configuration respectively, propose enhanced resource allocation mechanisms for configured grant based SL resource allocation in Mode 1.

For dynamic grant-based transmission, the users make requests for transmission resources in an aperiodic fashion. The gNB upon knowing the directionality or direction of transmission may perform a higher occurrence of frequency reuse by allocating the same time-frequency (T-F) resource to multiple devices in a given geographic zone or area. The SL devices communicating over the overlapping T-F resource may be in physical proximity, but collisions may be avoided by making use of the directionality information made available to the gNB and the directional nature of transmissions. The last two embodiments in this disclosure, entitled SL Devices Providing Transmission Direction Indication for Dynamic Grant SL Transmissions and gNB configuration of Direction Specific SR/PUCCH Resources for Dynamic Grant SL Transmissions respectively propose enhanced resource allocation mechanisms for dynamic grant-based SL resource allocation in Mode 1.

The descriptions below address time-frequency resource allocation for SL Mode 1 operations. As used herein, aggressive T-F resource allocation refers to an allocation that utilizes a high occurrence of frequency reuse in a given geographic area that normally would not be suitable due to time and frequency collisions that may occur with a high occurrence of frequency reuse. One example of a high occurrence of frequency reuse is the assignment of the same T-F resource to multiple D2D communication pairs in a given physical area.

Aggressive Time-Frequency Resource Allocation for Configured Grants with Direction Information and Updates

When SL devices are operating in Mode 1 based resource allocation, the gNB upon knowing the directionality or direction of the transmission may instruct a higher occurrence of frequency reuse, by providing the same time-frequency (T-F) resource allocation to multiple devices in a given geographic zone or area. For example, in an aggressive T-F allocation, a gNB may make more assignments of the use of a given frequency in a geographic area. The SL devices communicating over the same T-F resources may be in physical proximity, but collisions may be avoided by making use of the directionality information made available to the gNB and the directional transmissions.

One important aspect of this innovation is related to the fact that it does not change the NR SL design or SL signaling itself. The mechanisms discussed herein are primarily introducing the SL direction information indication to the gNB. This requires an update of cellular Uu interface to provide such indication from SL devices to the network. As the cellular Uu communication is between the gNB and a WTRU, the change does not need to be modified to be backward compatible. Thus, the new WTRUs with SL interface(s) may provide the proposed indication to the network, allowing the network to schedule the same time-frequency SL resources to multiple communicating pairs (higher number of occasions of frequency reuse within a given area) resulting in a significant boost in system capacity. The network can schedule these SL devices in a prioritized fashion or by allocating the communication resources from a bigger pool due to availability of knowledge related to a transmit direction, which may provide an incentive to these users to provide the additional knowledge.

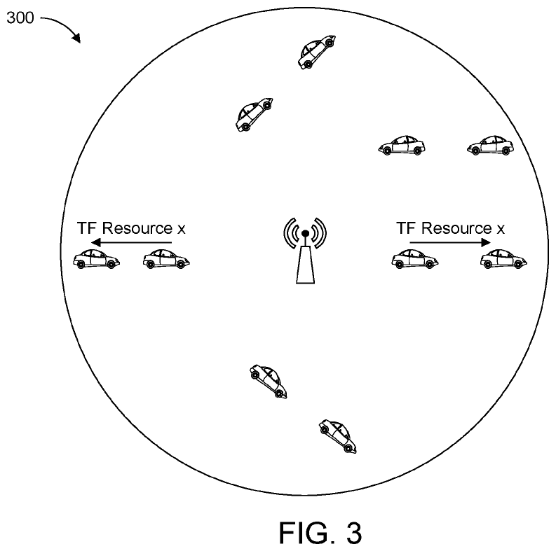

FIG. 3 shows a scenario where the gNB has no information about the transmission directions. It may still try to schedule two users with the same time frequency (T-F) resource if it has information about their location being far apart from each other. Despite this, the gNB may not be certain if the resulting transmissions will collide or not as it has no information in which direction the scheduled SL devices will transmit over the allocated resource.

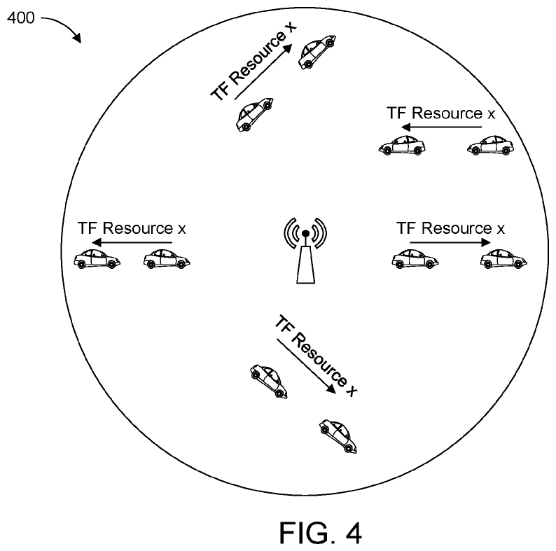

FIG. 4 shows a scenario where the gNB has the knowledge of transmission directions in which SL devices intend to transmit. This lets the gNB schedule the same time frequency (T-F) resource to many SL pairs in a given geographic area. The directionality information provides the key to schedule resources simultaneously with no or harmless collisions among the communicating pairs. Location information of SL pairs is also of interest. The discussion herein considers Mode 1 based allocation where the SL Txs are in the network coverage (e.g. a communication cell), and in RRC connected mode. This implies that the gNB will have an estimate of their location.

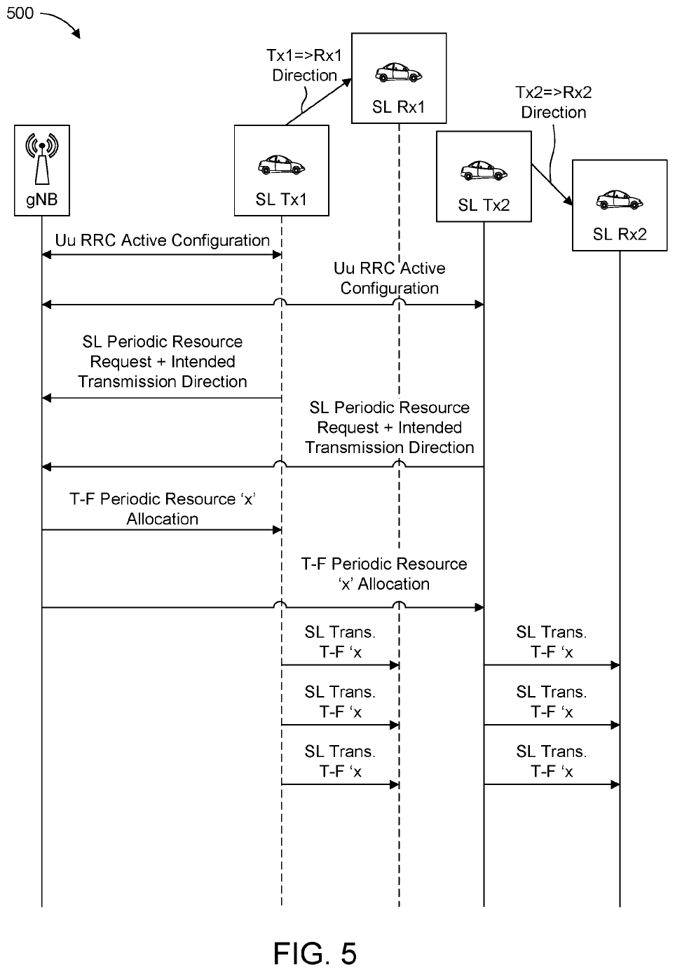

In configured grant (CG) based resource allocation, WTRUs, e.g., SL Txs, may provide the indication of intended transmission direction to the gNB. As WTRUs, e.g., SL Txs, will be exchanging RRC messages with the gNB during the CG configuration anyway, the indication of intended direction can be added along with other information bits transmitted to the gNB according to principles of this disclosure. In fact, due to RRC exchanges between the network and WTRUs, larger number of bits can be accommodated. Thus, precise direction information can be indicated to the gNB. The direction indication adds flexibility in the gNB scheduling. Having this information allows the gNB to schedule the same time frequency resource to multiple SL Txs in a given geographic area, without harmful collisions. This results in significant increase in the system spectral efficiency. An example message flow is shown in FIG. 5 where SL Tx1 and SL Tx2 need CG resources. Having the direction information about these transmitters and the knowledge that the intended transmission directions are not interfering, the gNB may allocate the same periodic time frequency resource ‘x’ to these transmitters. In FIG. 5, SL Tx1 and SL Tx2 transmit to their respective SL receivers, SL Rx1 and SL Rx2. Both sets have an active RRC configuration. Both transmitters provide to the gNB an indication of SL periodic resource request and intended transmission direction. The gNB provides both transmitters a T-F periodic resource allocation labeled ‘x’ because the direction information of both transmitters is different and not interfering. Hence, both Tx and Rx pairs use the T-F allocation ‘x’ for transmissions.

### Encoding of Direction Information

The following sub-sections provide some approaches on how the SL Tx can provide the indication of its intended transmit direction to the gNB.

### Direction Against an “Absolute Reference”

The direction information may be provided with respect to an absolute reference direction, e.g., cardinal North. Absolute directions in terms of degrees, minutes, seconds with respect to a global reference, e.g., compass bearing, may be provided.

Direction with Reference to the gNB Position

In an alternate approach which may be optionally combined with other direction indication schemes, the SL Tx may encode the intended transmit direction information against the gNB location. Thus, the direction information may include of the angle at the SL Tx between (i) a line joining SL Tx and the gNB, and the intended transmit direction from SL Tx to the intended SL Rx. As WTRUs will continuously track the signals from their gNB to properly receive and transmit with them, they will have continuous tracking of gNB direction. This allows easy encoding of intended transmission direction at the SL Tx. Similarly, as the gNB will be tracking the SL Tx with which it is exchanging messages in RRC active state, the gNB can decode and interpret the received direction information from the SL Tx.

For example, direction relative to the angle of arrival of the downlink synchronization signal/physical broadcast channel (SS/PBCH) block selected by the WTRU (e.g., for Random Access Channel association and transmission) may be indicated to the gNB as a direction relative to the gNB. For the target direction of a WTRU's SL transmission, both azimuth (e.g., horizontal) and elevation (e.g., vertical) angles relative to the angle of arrival of the selected downlink SS/PBCH block (e.g., in terms of angular units such as degrees, minutes, seconds) may be indicated to the gNB.

### SL TX/Rx Zone Indication to the gNB

In an alternate approach which may be optionally combined with other direction indication schemes, the SL Tx may provide the indication of its intended transmission direction by providing the zone identity (ID) of the SL Rx. SL Tx may have the knowledge of SL Rx zone ID. Otherwise; it can request this information from its intended SL Rx as part of the configuration. A SL Tx may derive its SL zone ID as per the SL configuration. The SL Tx may send the Rx zone ID, and potentially its own zone ID to the gNB. SL Tx zone information may be optional as the gNB has access to SL Tx's location information through other mechanisms such as estimating the signals transmitted by SL Tx on Uu interface.

### Update of Directionality Information for the gNB

As periodic resources, shown in FIG. 5, are allocated for a given duration, and the SL devices may be mobile or the channel between the SL Tx and SL Rx may change due to any change in the environment, e.g., blockages, the direction of transmission may change within the active duration of periodic resources. This may result in two periodic transmissions colliding which were not colliding prior to change of transmission direction. To combat such situations, this disclosure proposes that the WTRUs inform the gNB about the change in the transmission direction.

The SL devices may track their intended transmission direction through message exchanges, transmission of reference signals, and measurements reports. The SL Tx may transmit reference signals, for example multiplexed within the control (e.g., physical sidelink control channel (PSCCH)) or/and data channels (e.g., physical sidelink shared channel (PSSCH)) of the CG transmissions to its SL Rx. The SL Rx may make measurements using the reference signals transmitted within the control or/and data channel. The measurements may be for example in the form of Received Signal Received Power (RSRP), Received Signal Strength Indicator (RSSI), or/and Signal to Interference and Noise Ratio (SINR). The SL Rx may report measurements back to the SL Tx. Such measurements may be used by the SL Tx to determine if the transmit direction or/and the resources need to be updated for the future transmissions to the SL Rx. For example, in case of high interference observed by the SL Rx, the SL Tx may determine to change the direction of the transmission to the SL Rx.

When the SL Tx determines to change the transmission direction and the transmission direction change with respect to (w.r.t) the previous indicated direction to the gNB is beyond a certain threshold, a WTRU will provide the updated transmission direction indication to the gNB. One possibility can be to define a new RRC message from WTRU which updates the directionality information in a periodic or aperiodic manner. In a design compatible with other approaches, direction information update (or indication of update) can be transmitted along with SL HARQ feedback, sent on PUCCH to the gNB. The direction information update can be transmitted in a hybrid manner as well, where the change indication may be transmitted at PHY level, e.g., using PUCCH, with the detailed information, e.g., containing the direction information, transmitted on RRC.

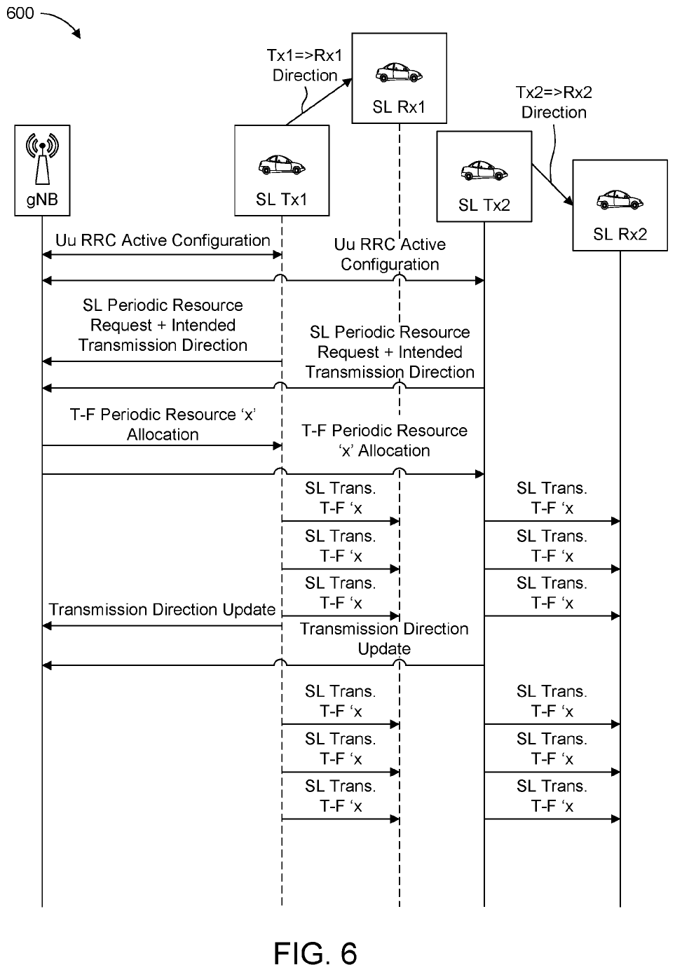

FIG. 6 shows a scenario where the gNB has configured two SL Txs over the same time frequency periodic resource. When it receives the update from the two Txs, it evaluates if the updated transmission directions can still co-exist or not. FIG. 6 is set such that the updated directions don't risk a collision and the gNB does not need to update the resource configuration. In FIG. 6, SL Tx1 and SL Tx2 transmit to their respective SL receivers, SL Rx1 and SL Rx2. Both sets have an active RRC configuration. Both transmitters provide to the gNB an indication of SL periodic resource request and intended transmission direction. The gNB provides both transmitters a T-F periodic resource allocation labeled ‘x’ because the direction information of both transmitters is different and not interfering. Hence, both Tx and Rx pairs use the T-F allocation ‘x’ for transmissions. Further in FIG. 6, SL Tx1 and SL Tx2 provide the gNB with transmission direction updates. The gNB does not change the T-F allocation for either SL Tx1 or SL Tx2 because the updates to the direction of both transmitters allows the T-F resources of both transmitters to remain the same.

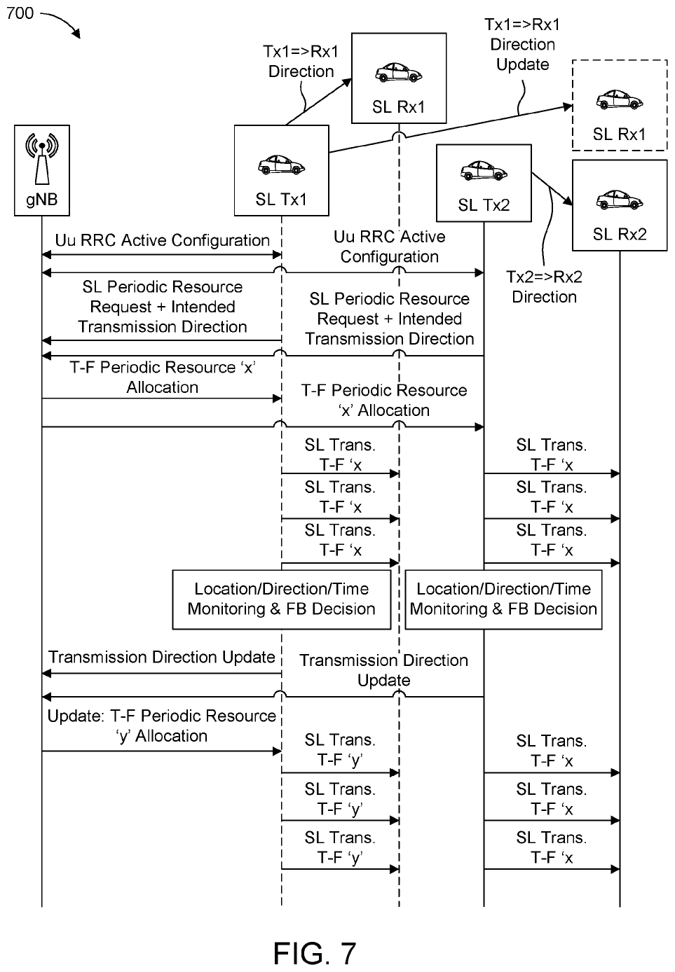

FIG. 7 shows an example scenario where SL Rx1 has moved to a new location and the updated transmission directions received from SL Tx1 and SL Tx2 enable the gNB to estimate that the transmissions from these two Txs have a higher risk of collision. In this case, the gNB may decide to change the resource configuration of at least one transmission to avoid such collisions. In this figure, the gNB provides an updated configuration to SL Tx1, and both pairs can communicate free of collision risk. In FIG. 7, SL Tx1 and SL Tx2 transmit to their respective SL receivers, SL Rx1 and SL Rx2. Both Txs have an active RRC configuration. Both transmitters provide to the gNB an indication of SL periodic resource request and intended transmission direction. The gNB provides both transmitters a T-F periodic resource allocation labeled ‘x’ because the direction information of both transmitters is different and not interfering. Hence, both Tx and Rx pairs use the T-F allocation ‘x’ for transmissions. However, both SL Tx1 and SL Tx2 monitor changes in direction of their receivers SL Rx1 and SL Rx2 respectively. The decision to feedback (FB) the updated estimate of transmit direction to the gNB is taken as per the configuration. According to the direction update configuration, the transmission of direction feedback can be configured as a periodic update or as an aperiodic update with a transmission direction FB criterion. For example, if the detected change in the direction exceeds a configured threshold, then a SL Tx will report the transmission direction change to the gNB. In the instance of FIG. 7, both SL Tx1 and SL Tx2 report transmission direction update FB information to the gNB. Here, the gNB decides to change the T-F allocation of SL Tx1 to be T-F allocation “y”. SL Tx2 continues to use T-F allocation “x” and there are no transmission collisions.

Direction update information may contain the new direction information with respect to (w.r.t.) to absolute reference direction and/or w.r.t. the SL TX's selected DL SS/PBCH with the serving gNB. Alternatively, direction update information may contain the new SL Tx or/and SL Rx zone information for example when there is any change in the zone of Tx or Rx. Alternatively, direction update information may contain the relative direction, for example both azimuth (e.g., horizontal) and elevation (e.g., vertical) angles relative to the previous/last direction indicated by the SL Tx to the gNB for the same transmission (e.g., in terms of angular units such as degrees, minutes, seconds).

### Periodic Update for Direction Indication

The update of transmission information can be periodic with a configured period. This could be part of a configured grant configuration. The SL Tx may be configured with an uplink resource configuration to send periodic updates for direction indication. The configuration may include at least one of periodicity, time offset, prohibit timer, uplink control channel (e.g., PUCCH) configuration (e.g., format, time/frequency resources, etc.), etc. Alternatively, the WTRU may use a higher layer signaling, e.g., sending a RRC message, containing the new direction indication. Periodic resources, e.g., over the uplink data channel, may be configured to send RRC messages. Alternatively, the direction information update can be transmitted in a hybrid manner, where the change indication may be transmitted using configured periodic resources over the uplink control channel, and then the WTRU may receive a grant containing the uplink resources, e.g., over the uplink shared channel, and the WTRU may send detailed information, e.g., containing the direction information, using the configured uplink resource, e.g., over the uplink shared channel.

For each period, a SL Tx will update the gNB about its current direction for the transmission with its SL Rx. Each update can be in the form of the absolute direction, and/or the difference with respect to previous direction indicated as per the encoding strategy configured for the direction indication.

### Aperiodic Update for Direction Indication

The periodic updates simplify the design but may increase the signaling overhead. That could be un-necessary when in a given period the direction has not changed significantly. In a design compatible with other approaches, to overcome the fixed overhead of the periodic updates, the transmission direction indication updates can be trigger or event based. SL Tx may be configured with thresholds (e.g., as a part of the CG configuration) which can be used to check against the change in direction of transmission and to determine if the change is required to send a transmission direction update or not. These triggers and thresholds can be applied against the change of transmission direction or change of SL Tx's own location or a combination thereof.

The SL Tx may be configured with periodic uplink resources. This could be part of configured grant configuration. The SL Tx may send the information associated with new direction of transmission using the next available uplink resource when the change in the direction w.r.t. the previous indicated direction is above the given threshold. Alternatively, the SL Tx may send a scheduling request (SR) to the gNB to allocate uplink resources to update the direction information when the change in the direction w.r.t. the previous indicated direction is above a given threshold. The SL Tx may use the allocated uplink resource to send the information associated with new direction of transmission. The information indicating the new direction of transmission may be sent by the SL Tx as an UL MAC-control element (MAC-CE) message.

### Resource Collision Management

In this section, the mechanisms are provided on how to avoid the collisions when the same time frequency resource is allocated to more than one SL communicating pair, and due to mobility or change of environment, and the two transmissions face a collision risk.

### Update of Configured Grant Resource by the gNB

In one approach, the gNB keeps track of the pairs allocated the same time frequency resource, and it keeps monitoring their status with respect to the updates of intended transmission directions received through the scheduled SL Txs. After the reception of Tx location/direction indication, if the gNB estimates that there is a collision risk, it can update the CG configuration of at least one of the communicating pairs allocated the same time frequency resource. This may involve RRC re-configuration message exchanges between the gNB and the SL Tx(s). This may result in some delay until the configuration is complete before the SL Tx can use the newly configured CG resource. For example, after receiving the RRC re-configuration, the new configuration may be applied from symbol/slot/sub-frame ‘n+L’, where ‘n’ may be the symbol/slot/sub-frame in which the SL Tx receives the RRC re-configuration message, and ‘L’ may be a time offset (e.g., number of symbols/slots/sub-frames or an absolute time value) which may be communicated to the WTRU by the gNB, e.g., as a part of the CG configuration. This mechanism may follow the example message exchanges as shown in FIG. 7.

### Multiple Configurations and Activation of Suitable Configuration Through DCI

In this section, a novel design is proposed which allows handling the collision risk in a much more dynamic manner without the need for long RRC message exchanges.

In this approach, as part of the periodic resource configuration, the gNB provides multiple CG configurations, e.g., multiple resource configurations, to a SL Tx, and activates one suitable configuration. Each configuration may include of one of more of the parameters including configuration identity (e.g., id), time-frequency resource allocation, periodicity, total time duration, etc.

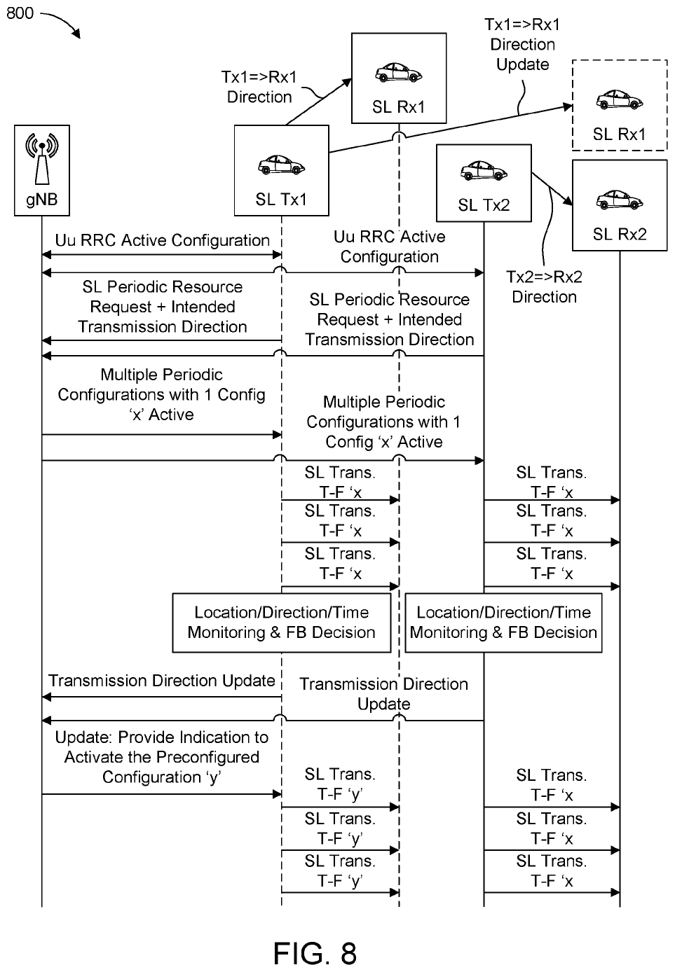

After the Tx location/direction indication, if the gNB decides to change the active CG configuration, it can simply send a DCI activating a different appropriate CG configuration, e.g., another configuration selected from the multiple CG configurations communicated to the SL Tx. This can be easily achieved by defining a number of bits in the downlink control information (DCI) and specifying the mapping of each bit with one of the CG configurations. This mapping can be part of the initial CG configuration. As in this mechanism, the gNB just needs to transmit a simple DCI to activate a different suitable CG configuration, this results in much faster and dynamic change of resource. Such configuration and update of configuration are shown as an example in FIG. 8. In this figure, the gNB has configured multiple CG configurations to SL Tx1 and SL Tx2. At a later stage, having received the updated transmission directions, the gNB decides to change the configuration for SL Tx1, and indicates through DCI to shift to a different configuration (resource ‘y’).

FIG. 8 is similar to FIG. 7 in that SL Tx1 and SL Tx2 transmit to their respective SL receivers, SL Rx1 and SL Rx2. Both Txs have an active RRC configuration. Both transmitters provide to the gNB an indication of SL periodic resource requests and intended transmission direction. In the example of FIG. 8, each transmitter SL Tx1 and SL Tx2 receives multiple periodic configurations. Thus, each transmitter has a set of configurations to reference. The gNB also provides each transmitter with an indication that configuration ‘x’ is active for each. SL Tx 1 and SL Tx2 can transmit to their respective receivers using T-F ‘x’ without transmission collisions. Both SL Tx1 and SL Tx2 monitor changes in direction of their receivers SL Rx1 and SL Rx2 respectively. The decision to feedback (FB) the updated estimate of transmit direction to the gNB is taken as per the configuration. According to the direction update configuration, the transmission of direction feedback can be configured as a periodic update or as an aperiodic with a transmission direction update criterion. For example, if the detected change in the direction exceeds a configured threshold, then a SL Tx will report the transmission direction change to the gNB. In the instance of FIG. 8, both SL Tx1 and SL Tx2 report transmission direction update FB information to the gNB. Here, the gNB decides to change the T-F allocation of SL Tx1 to be T-F allocation “y”. The change in configuration for SL Tx1 is quicker than in FIG. 7 because the updated configuration for SL Tx1 is provided as a reference to a pre-configured configuration ‘y’. As indicated above, such a configuration update may be provided via a DCI message to which SL Tx1 can quickly decode and react by updating the active SL configuration. SL Tx2 continues to use T-F allocation “x” and there are no transmission collisions.

Variation with Cone of Operation for Configured Grants with Direction Information and Updates

As used herein, the term “the cone of operation” may define an area of a signal propagation/use which represents the area where this signal can be received with at least a given signal energy. The term “directional information” may be used with equal meaning herein to “cone of operation”. This cone of operation (directional information) is in the shape of a conic beam transmitted by a sidelink device. Thus, the parameters defining this cone of operation (also termed “directional information”) include the location of the SL transmitting device, the direction of transmission (or direction of SL receiving device from the transmitting device) and the range of transmission (which is dictated by transmission power and the channel impairments). The cone of operation can be defined more precisely considering the antenna patterns (side lobes and respective antenna gains), transmission power, and the side information about the terrain/maps/blocking objects etc. Thus, the cone of operation associates an area to a transmitted signal or time-frequency (T-F) transmission resource where the resource (e.g. a transmission signal in a specific time-frequency resource allocation) can be received with a non-negligible signal energy. It is noted that a concurrent use of the specific time-frequency resource by another device may cause a harmful collision if the same time frequency resource is used within the cone of operation of a sidelink device that is already allocated the specific time-frequency resource.

With this terminology in place, a slight variation of any of the examples herein can be as in the following: the SL Tx requests periodic resources from the gNB and sends along its current estimate of its cone of operation. The gNB allocates periodic resources to this WTRU. With the knowledge of cone of operation for this SL Tx, the gNB can utilize very high occurrence of frequency reuse (high occasion or instance of T-F resource use) for SL resources because the gNB can estimate very well the colliding pairs. Then the SL Tx tracks its own cone of operation. As in the description of the above examples, the SL Tx can provide periodic or aperiodic updates about its cone of operation. The gNB, upon receiving the fresh information of the cone of operation from the SL Tx, may update the periodic resources in an instance where the gNB estimates that there is a risk of collisions among the SL pairs configured with same periodic time frequency resource. The indication from the gNB can be a RRC message or a physical layer indication leading to the activation or selection of a different pre-configured resource allocation configuration.

In a different variation of the example cone of operation use, the gNB can exploit the fact that the gNB has the information about the SL Tx location (SL Tx being in RRC active mode). Thus, the SL Tx can provide the feedback to the gNB which allows the gNB to compute the cone of operation for this SL Tx. The SL Tx can provide one or a combination of Rx location (for example as precise geographic coordinates or in the form of SL zone where SL Rx is located), transmission direction, transmission power, beamwidth to the gNB. Combining this feedback with the most recent location estimate for the given SL Tx, the gNB determines the cone of operation for this SL Tx signal. Based upon this cone of operation, and the scheduler's knowledge for different pairs scheduled with the same set of periodic SL resources, the gNB can decide to update the SL periodic resource for this SL Tx.

The gNB Control of the SL Transmission Power for Configured Grants with Direction Information and Updates

In a compatible design, the gNB may provide a SL Tx an indication of transmit power in addition to the periodic time frequency resource configuration based on the indicated direction of SL transmissions. This transmit power can be the actual transmit power to be used for the SL transmission, or it can be an upper bound (e.g., maximum transmit power) which a SL Tx should not cross while transmitting over this SL allocated resource. By providing an indication of SL transmit power, be it the transmission power or the limit on the transmit power, the gNB can control in a fine grain manner the range or cone-of-operation for the SL transmission from a given SL Tx. This allows the gNB scheduler plan the higher occurrence of frequency reuse in a systematic manner by ensuring that the transmissions from certain SL Txs will stay within certain zones dictated by the SL transmit power indication.

In one example, when the multiple resource configurations are given to the SL Tx where only one resource is activated, the SL Tx power can be provided for each resource configuration as part of the initial configuration. In an alternative design, the transmit power indication may be communicated to the WTRU at the time of the activation of the resource. The transmit power indication may be sent with the activation indication of the associated resource.

### Example First Embodiment of Periodic/CG Resource Allocation from gNB

This first example embodiment describes a method performed by a SL WTRU to request periodic/configured-grant resource allocation from the gNB.

A SL Tx WTRU sending a CG resource request and a direction indication for the intended transmission to the gNB, the SL Tx WTRU taking the following actions:
Receiving a first periodic time-frequency resource configuration from the gNB;
Performing transmission to a SL Rx using the first time-frequency resource configuration;
Sending a new transmission direction indication to the gNB when the transmission direction changes beyond a certain threshold compared to the previous indicated direction to the gNB;
Receiving a second periodic time-frequency resource configuration from the gNB;
Performing transmission to the SL Rx using the second time-frequency resource configuration.

The above first example embodiment may include the following:
The direction information indication may be provided with respect to an absolute reference direction, e.g., cardinal North, or may be provided in terms of degrees, minutes, seconds with respect to a global reference, e.g., compass bearing.
The direction information indication may be provided relative to the angle of arrival of the downlink SS/PBCH block of the gNB selected by the WTRU, where both azimuth (e.g., horizontal) and elevation (e.g., vertical) angles relative to the angle of arrival of the selected downlink SS/PBCH block (e.g., in terms of angular units such as degrees, minutes, seconds) may be indicated to the gNB.
The direction information indication may include SL Rx zone ID.
The SL Tx may track the direction of transmission from the measurement reports received from the SL Rx.
The SL Tx may send the direction indication updates to the gNB in a periodic fashion using the configured periodic UL resources over the uplink control channel or as a RRC signaling using the configured periodic UL resources over the uplink data channel.
The SL Tx may send the direction indication using the next available configured periodic uplink resource when the change in the direction w.r.t. the previous indicated direction is above the given threshold.
The SL Tx may send a SR to the gNB to allocate uplink resources to update the direction information when the change in the direction w.r.t. the previous indicated direction is above the given threshold and may use the allocated uplink resource to send the information associated with new direction of transmission.
After sending the information associated with new direction of transmission, the second periodic time-frequency resource configuration may be received as a RRC re-configuration message from the gNB.
After sending the CG resource request, the SL Tx may receive multiple resource configurations with an indication of first active configuration which can be used for the initial transmissions to the SL Rx, then may receive an indication of second active configuration from the gNB after sending the information associated with new direction of transmission and may use the second active configuration for the next transmissions to the SL Rx.
In the above procedure, the SL Tx may track its cone of operation which may include computation(s) using a combination of (i) SL Tx location, (ii) SL Rx location, (iii) direction of transmission, (iv) transmission beamwidth, (v) transmission power and may use the cone of operation information to be sent to the gNB for resource (re)configuration.
In the above procedure, the SL Tx may use one or a combination of parameters including SL Rx location, transmission direction, transmission power, beamwidth to be sent to the gNB for resource (re)configuration.
WTRU receiving an indication of transmit power to be applied for the SL transmission as part of SL resource configuration.
With multiple resource configurations provided, WTRU receiving an indication of transmit power to be applied for the SL transmission for each resource configuration.
   Aggressive T-F Resource Allocation for Configured Grants with SL Rx Indication

In this example embodiment, a SL Tx while requesting periodic resources from a gNB, informs the gNB about the identity (ID) of the SL Rx device to which it intends to transmit data over these periodic resources. A suitable ID for the SL Rx is communicated which is understandable at the network/gNB. As SL Tx is requesting the resources, it has active RRC connection with the gNB, so the gNB already knows the ID and location for the SL Tx. Having the knowledge of the suitable ID for the SL Rx, the gNB has full knowledge of the SL pair who will be communicating over the SL periodic resources. The gNB can thus determine the SL Rx location and even track its movement when the SL Rx is connected to the same network. With this information, the gNB can determine the transmission direction from the SL Tx to the SL Rx. Beyond the transmission direction knowledge, with the power control and beam width parameters, even if they are not precisely known, the gNB can have a fair estimate of the geographic zone in which transmission power from this given SL Tx will be received. This allows greater scheduling flexibility for the gNB than scheduling without location information. The gNB can then schedule the same time frequency resource for more than one SL communicating pair for which the gNB knows the SL Tx/Rx IDs/locations, and upon estimating that these pairs will have no or minimal interference. This allows very aggressive SL frequency reuse in a given geographic area, resulting in significant increase in the system spectral efficiency.

An important technical advantage in this example embodiment with SL Rx indication is that the gNB can determine the SL Rx location and can schedule the time frequency resources in a suitable manner. Thus, there is an advantage that no direction updates are needed from the SL Tx. The mobility of SL Tx and/or SL Rx may result in change of transmission direction and the zone in which transmission power from a given SL Tx is received. This results in change in the interference zone as well. Knowing the suitable IDs for the SL Tx and SL Rx, the gNB can track the pair, and can determine the zone in which transmission power can be received from this SL Tx. Thus, no explicit direction updates are needed from SL Tx in this example embodiment.

SL Rx Indication for the gNB—Signaling Flow Diagram

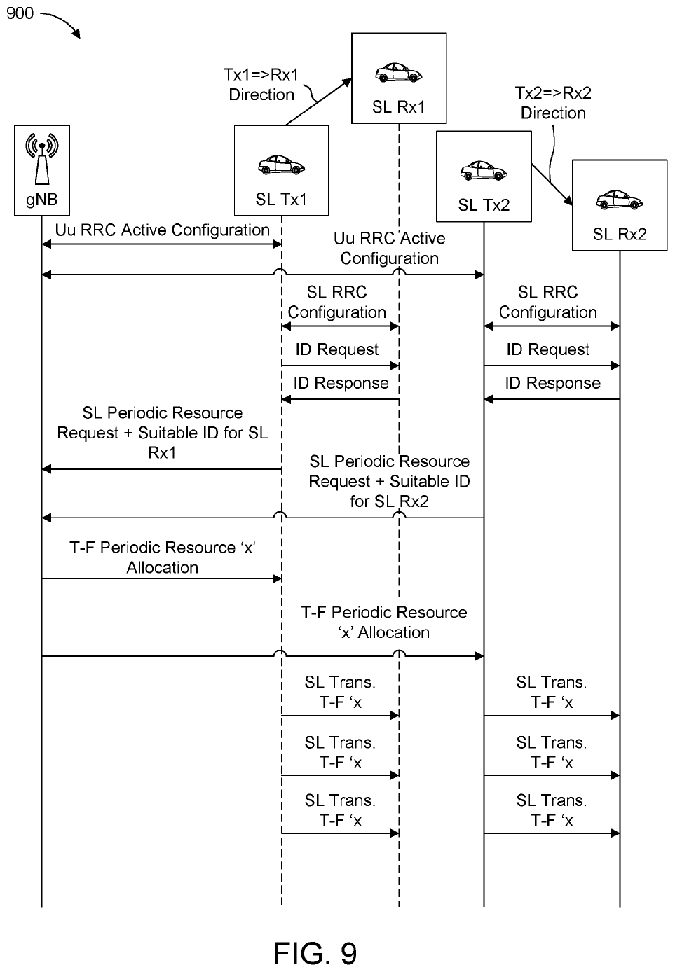

FIG. 9 shows the signaling or message flow diagram for an example scenario of two SL communicating pairs when the SL Tx(s) transmit a suitable ID for their intended SL Rx(s). The flow diagram shows that prior to requesting periodic resources, a SL Tx will request an ID from its SL Rx to be later communicated to the gNB. This exchange can happen when a SL pair is establishing SL RRC connection. In a different approach, SL Tx can request the SL Rx ID prior to requesting periodic resources from the gNB. SL Tx will indicate the SL Rx ID to the gNB while requesting periodic SL resources. In this example figure, having the knowledge of two communicating pairs with no/minimal interference risk, the gNB schedules the same time frequency resource to both pairs.

### Indication of Suitable WTRU ID for the SL Rx

If a SL Tx is requesting periodic SL resources to communicate with another SL device, and SL Tx requests periodic resources from the gNB, SL Tx will be in SL RRC Connected state with this SL Rx. If SL Tx sends the SL Rx ID to the gNB, SL Rx ID may not mean much to the gNB as a given SL device may generate multiple SL IDs each associated with a different service. It could make sense that SL Tx indicates an ID of SL Rx to the gNB that the gNB can understand. This disclosure proposes to use International Mobile Equipment Identity (IMEI) of SL Rx as this suitable/selected ID. This could also let the gNB identify when that device comes in-coverage or goes out-of-coverage. Then SL Tx can send this IMEI to the gNB as part of RRC information exchanges happening to do the configuration of SL configured grant. With IMEI, there could be some privacy concerns in sharing this ID to another device (SL Rx sharing its IMEI with SL Tx so that it can relay this ID to the gNB). For this reason, this disclosure also proposes to use alternative IDs which the gNB can understand. International Mobile Subscriber Identity (IMSI) could be one such alternative. Further, temporary version in the form of Temporary Mobile Subscriber Identity (TMSI) or System Architecture Evolution (SAE)-TMSI (S-TMSI) or 5G-S-TMSI may also be used as the ID to be communicated to the gNB. Such IDs may be used by the network to track a SL Rx both in RRC Connected and RRC Idle/Inactive states. A positioning solution for RRC Idle/Inactive state may enable the network to track a WTRU in its RRC Idle/Inactive state. Alternatively, Radio Network Temporary Identifier (RNTI) of the SL Rx may be used as the ID to be communicated to the gNB, specifically for the cases in which the SL Rx remains in the RRC Connected state over the Uu interface for the (e.g., at least) duration of CG transmissions between the SL Tx and SL Rx.

### Transmissions Tracking and Resource Collision Management

In this section, the mechanisms are provided on how to avoid the collisions when the same time frequency resource is allocated to more than one SL communicating pair, and due to mobility or change of environment, the two transmissions may face a collision risk.

### Update of Configured Grant Resource Through RRC Re-Configuration

In the first example approach, a single resource configuration is configured and activated by the gNB. Though the same resource can be configured by the gNB to multiple SL Tx(s). The gNB keeps track of the pairs allocated the same time frequency resource, and it keeps monitoring their status.

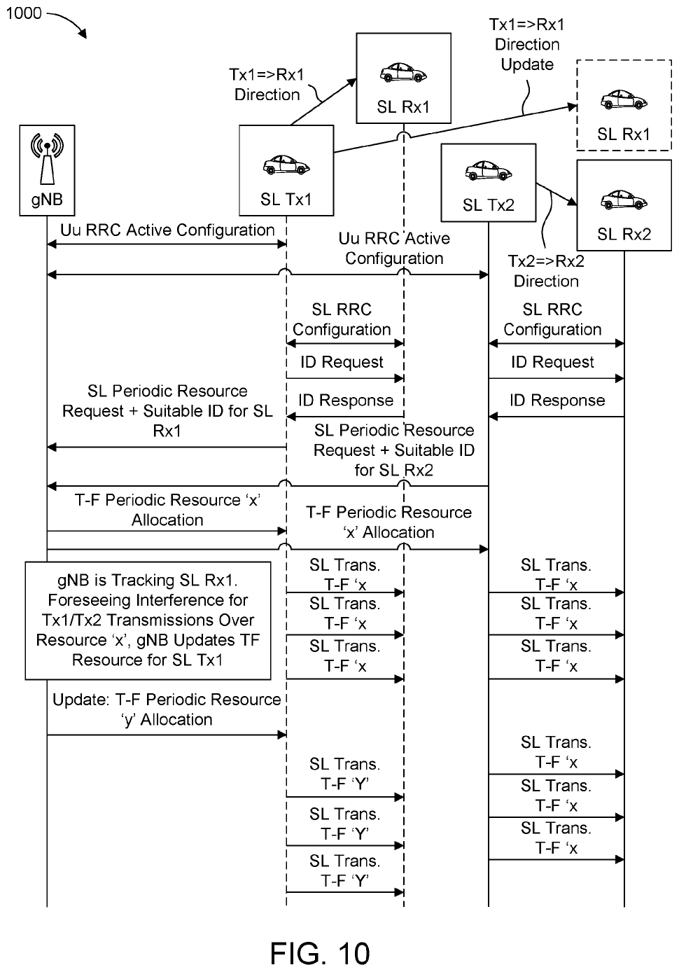

When the gNB estimates that there is a collision risk, it can update the CG configuration of at least one of the communicating pairs allocated the same time frequency resource. This may involve RRC re-configuration message exchanges between the gNB and the SL Tx(s). This may result in some delay until the configuration is complete before the SL Tx can use the newly configured CG resource. This mechanism will follow the message exchanges as shown in FIG. 10.

FIG. 10 is similar to that of FIG. 9 where SL Tx1 and SL Tx2 transmit to their respective SL receivers, SL Rx1 and SL Rx2. Both sets have an active RRC configuration. The SL Tx1 and SL Tx2 request an ID and receive the ID from their respective receivers SL Rx1 and SL Rx2. Both SL Tx1 and SL Tx2 report their respective periodic resource requests along with the respective receiver ID to the gNB. In the example of FIG. 10, both transmitters are given a T-F resource allocation of ‘x”. Both use the resource allocation ‘x’ to transmit to their respective receivers. In the example of FIG. 10, the gNB tracks SL Rx1 and estimates (foresees) interference for the two transmitters concerning the T-F resource ‘x’. The gNB then updates the T-F resource for one of the transmitters, SL Tx1, to T-F resource ‘y’. Thus, SL Tx1 uses T-F resource ‘y’ to transmit with its receiver SL Rx1 and SL Tx2 continues to use T-F resource ‘x’ to transmit with its receiver SL Rx2. The gNB thus averted a potential T-F resource collision between SL Tx1 and SL Tx2.

### Multiple Configurations and Activation of Suitable Configuration Through DCI

In this section, a novel approach is proposed which allows handling the collision risk in a much more dynamic manner without the need for long RRC message exchanges.

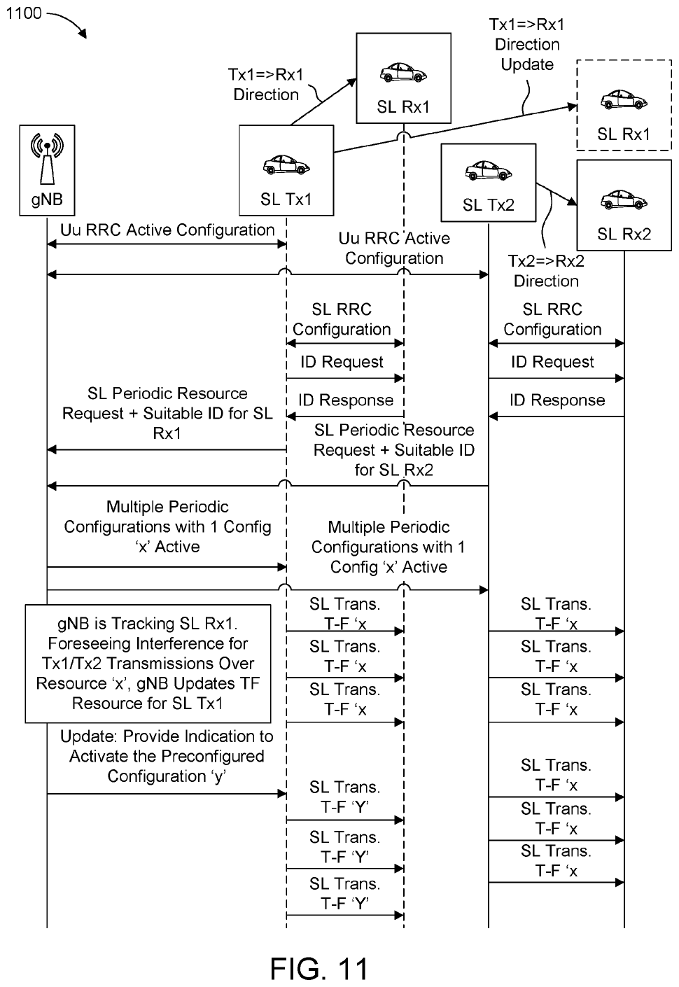

In this example approach, as part of the periodic resource configuration, the gNB provides multiple CG configurations to a SL Tx, and activates one suitable configuration which is relevant for the current location of SL Tx and SL Rx. Each configuration may include of one or more of the parameters including configuration identity (e.g., id), time-frequency resource allocation, periodicity, total time duration, etc. The gNB then keeps tracking the location for the SL pair having known their IDs. Later if the gNB decides to change the active CG resource estimating a collision risk among the pairs allocated the same time frequency resource, it can simply send a DCI to SL Tx activating a different appropriate resource configuration out of the multiple CG configurations given to the SL Tx. This can be easily achieved by defining a number of bits in the downlink control information (DCI) and specifying the mapping of each bit with one of the CG configurations. This mapping can be part of the initial CG configuration. As in this mechanism, the gNB just needs to transmit a simple DCI to activate a different suitable CG configuration, this results in much faster and dynamic change of resource. Such configuration and update of configuration are shown as an example in FIG. 11.

FIG. 11 is similar to that of FIG. 10 where SL Tx1 and SL Tx2 transmit to their respective SL receivers, SL Rx1 and SL Rx2. Both sets have an active RRC configuration. The SL Tx1 and SL Tx2 request an ID and receive the ID from their respective receivers SL Rx1 and SL Rx2. Both SL Tx1 and SL Tx2 report their respective periodic resource requests along with the respective receiver ID to the gNB. This request can have additional information such as an intended transmission direction. In the example of FIG. 11, each transmitter SL Tx1 and SL Tx2 receive multiple periodic configurations. Thus, each transmitter has a set of configurations to reference. The gNB also provides each transmitter with an indication that configuration ‘x’ is active for each. SL Tx1 and SL Tx2 can transmit to their respective receivers using T-F ‘x’ without transmission collisions.

In the example of FIG. 11, the gNB tracks SL Rx1 and estimates (foresees) interference for the two transmitters concerning the T-F resource ‘x’. The gNB then updates the T-F resource for one of the transmitters, SL Tx1, to T-F resource ‘y’. This update of the T-F resource allocation to SL Tx1 is provided by a DCI transmission to the SL Tx1. As explained above, the use of a DCI to change a T-F configuration is quickly implemented in the SL Tx1 device. Thus, SL TX1 uses T-F resource ‘y’ to transmit with its receiver SL Rx1 and SL Tx2 continues to use T-F resource ‘x’ to transmit with its receiver SL Rx2.

The gNB Control of the SL Transmission Power for Configured Grants with SL Rx Indication

In a compatible design, the gNB may provide a SL Tx an indication of transmit power in addition to the periodic time frequency resource configuration based on the determined direction of SL transmissions using the information of SL Rx given by the SL Tx. This transmit power can be the actual transmit power to be used for the SL transmission, or it can be an upper bound (e.g., maximum transmit power) which a SL Tx should not cross while transmitting over this SL allocated resource. By providing an indication of SL transmit power, be it the transmission power or the limit on the transmit power, the gNB can control in a fine grain manner the range or cone-of-operation for the SL transmission from a given SL Tx. This allows the gNB scheduler plan the higher occurrence of frequency reuse in a systematic manner by ensuring that the transmissions from certain SL Txs will stay within certain zones dictated by the SL transmit power indication.

In one example, when the gNB estimates that there is a collision risk between two SL pairs using the same allocated time-frequency SL resources, it can update the CG configuration of at least one SL pair by updating the time-frequency resource or transmit power or both.

When the multiple resource configurations are given to the SL Tx where only one resource is activated, the SL Tx power can be provided for each resource configuration as part of the initial configuration. In an alternative design, the transmit power indication may be communicated to the WTRU at the time of the activation of the resource. The transmit power indication may be sent with the activation indication of the associated resource.

### Example Second Embodiment of Periodic/CG Resource Allocation from gNB

This second example embodiment describes a method performed by a SL WTRU to request periodic/configured-grant resource allocation from the gNB. The advantage is that the gNB has access to SL Rx ID. The gNB already knows the SL Tx ID. Knowing both, the gNB can track SL device locations. In the situation that the gNB is utilizing very high occurrence of frequency reuse, (a high occurrence/incidence of the reuse of a T-F resource) if the two pairs come close to each other and potentially cause interference, the gNB can change the configuration of one pair. Thus, the advantages include (1) gNB tracking the locations for SL Tx and SL Rx, (2) indicating the update of resource in case of collision risk.

A SL Tx WTRU sending a CG resource request and a suitable identification of SL Rx to the gNB, the SL Tx WTRU taking the following actions:
Receiving a first periodic time-frequency resource configuration from the gNB;
Performing transmission to the SL Rx using the first time-frequency resource configuration;
Receiving a second periodic time-frequency resource configuration from the gNB;
Performing transmission to the SL Rx using the second time-frequency resource configuration.

The above second example embodiment may include the following:
The suitable/selected SL Rx ID is the ID is used which can be understood by the gNB, e.g., IMEI, IMSI, TMSI, S-TMSI, 5G-S-TMSI, or RNTI.
The SL Tx may receive the suitable/selected SL Rx ID from the SL Rx during the RRC connection setup between the SL Tx and the SL Rx.
The second periodic time-frequency resource configuration may be received as a RRC re-configuration message from the gNB.
After sending the CG resource request, the SL Tx may receive multiple resource configurations with an indication of first active configuration which can be used for the transmissions to the SL Rx, then later may receive an indication of second active configuration from the gNB and may use the second active configuration for the next transmissions to the SL Rx.
When multiple configurations are provided, the gNB can indicate the activation of a configuration through DCI signaling, where the configuration is not currently the active configuration.
The DCI signaling to activate a given CG configuration can be in the form of a bitmap where each bit may represent one of the possible configurations available to the SL Tx.
WTRU receiving an indication of transmit power to be applied for the SL transmission as part of SL resource configuration.
With multiple resource configurations provided, WTRU receiving an indication of transmit power to be applied for the SL transmission for each resource configuration.
   Aggressive T-F Resource Allocation for CG with Direction Specific Resource Set Configuration

### Main Idea and Flow Diagram

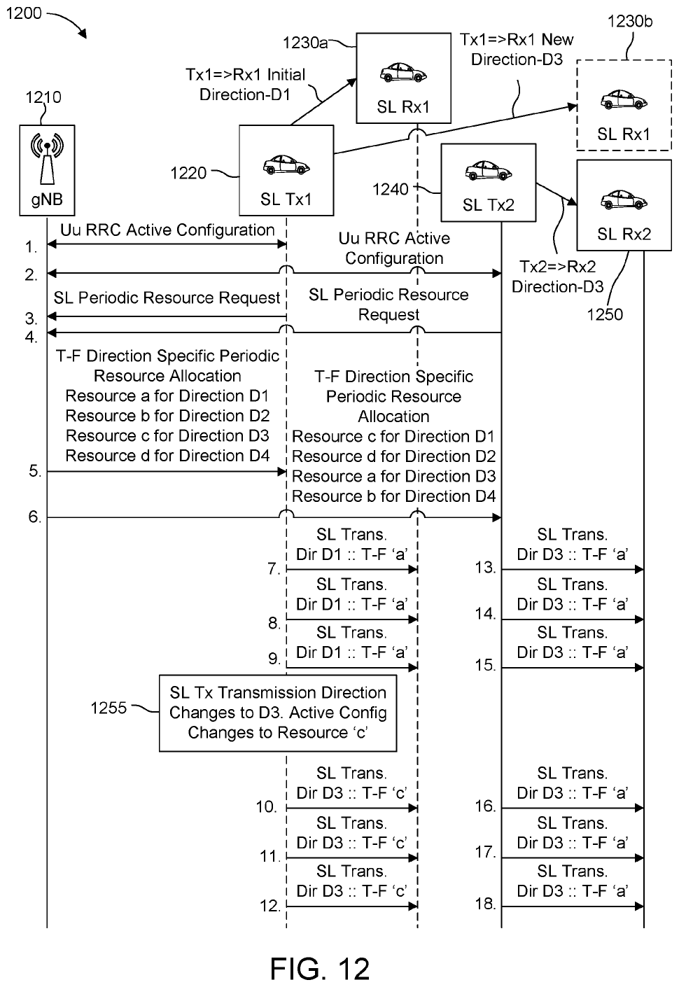

The main idea in this example embodiment for resource allocation for CG with direction specific resource set configuration is to enable aggressive frequency reuse (more instances/occurrences of reuse of a T-F resource) for SL transmissions while keeping the overhead minimal to enable this aggressive frequency reuse. This overhead is incurred in the form of direction tracking at a SL transmitting device, signaling and resource used for direction reporting to the network/gNB, and the resource update management by or in-collaboration with the network/gNB when there is risk of collision among the pairs using the same time frequency resource. This example embodiment proposes a novel approach for SL configured grant where the gNB provides multiple resource sets or multiple resource configurations as part of the SL device configuration. Each resource set is mapped to a specific Tx location (or zone) and its direction of transmission. The mapping of resources with location (or zone) and direction is also provided as part of resource configuration. Having received the resource configuration and mapping, the SL Tx will activate one suitable periodic resource as a function of its location (or zone) and intended direction of transmission. The SL Tx keeps monitoring its location (or zone) and tracks the transmission direction. If the change in location (zone) and/or transmission direction results in a new periodic resource as per the mapping provided by the gNB, the SL Tx will de-activate the current resource and activate the new resource as per the updated location (or zone) and transmission direction. An example diagram showing the relevant messages for this proposed innovation is shown in FIG. 12.

The multiple resource configurations are WTRU specific configurations. These multiple resource configurations need not imply any orthogonalization of resources. The mapping of resources to different directions/locations, or in a more general sense to different cones of operation (directional information) (e.g. any of location+direction+beamwidth+range) is different for different WTRUs. This allows a very high occurrence of frequency reuse because the gNB is able to perform a scheduling where the SL pairs in proximity will use the same time-frequency resource. In an instance where a WTRU makes a determination of a change of cone of operation or directional information (where their cones of operation may have overlap and transmissions may collide), the WTRU may change the resource configuration that the WTRU is currently using. The WTRU selects the resource configuration which maps to its most recent estimate of its cone of operation according to the configuration received from the gNB. This update of time-frequency resource for the overlapping cones of operation results in collision avoidance among the WTRU pairs operating in overlapping cones of operation. Thus, a WTRU may perform a resource configuration update if its currently used cone of operation changes such that, according to the gNB provided mapping, the new WTRU estimate of a cone of operation (e.g. any of location, or direction, or beamwidth, or range) maps to a different resource configuration provided by the gNB.

Example message exchanges for this innovation are discussed with respect to FIG. 12. FIG. 12 depicts a signal diagram 1200 of a Tx WTRU operation using direction specific information to use T-F resources. The signal diagram includes a Base Station 1210, such as a gNB, a sidelink transmitting WTRU (SL Tx1) 1220, a sidelink receiving WTRU (SL Rx1) 1230 at a first location 1230a and at a second location 1230b, a sidelink transmitting WTRU (SL Tx2) 1240 and a sidelink receiving WTRU (SL Rx2) 1250. SL Tx1 1220 transmits to SL Rx1 1230 with an initial direction of D1. SL Tx2 1240 transmits to SL Rx2 1250 with a direction of D3. At item 1, a Uu RRC active configuration is established between the BS 1210 and the SL Tx1 1220. At item 2 similar configuration is active between the BS 1210 and SL Tx2 1240. At item 3. SL Tx1 has a SL periodic resource request and at item 4, SL Tx2 has a SL periodic resource request.

At items 5 and 6, multiple direction specific periodic resource configurations are provided by the BS to the SL Tx1 and SL Tx2 respectively. At item 7, 8 and 9, SL transmissions occur between SL Tx1 and SL Rx1 while SL Rx1 is at a first location 1230a. These SL transmissions occur in direction D1 using T-F resource allocation ‘a’ provided by the BS 1210.

It is noted that SL transmissions 13, 14, and 15 between SL Tx2 and SL Rx2 also use T-F resource allocation ‘a’, but since the direction of transmission is different between SL Tx1 and SL Tx2, (direction D1 versus D3) then there is no collision of service between the pairs of transmitter and receiver WTRUs.

At box 1255, the SL Tx1 WTRU detects a change in the direction of its receiver SL Rx1. In the example, SL Rx1 is moving from a location depicted as 1230a to a location depicted as 1230b. Upon detecting or estimating/predicting the change in direction, SL Tx1 consults its configuration comprising of multiple direction specific resource configurations. In this instance, it is assumed that the direction of SL Rx1 has changed or is precited to change from direction D1 to D3. Direction D3 is already being used by SL Tx2 to transmit to SL Rx2 using T-F resource ‘a’. Thus, a collision may occur if SL Tx1 continues to use T-F resource ‘a’ for direction D3. Following the received configuration, SL Tx1 selects the active configured grant configuration to configuration ‘c’ which is mapped to the updated direction D3. SL Tx1 de-activates the previous configuration ‘a’ and activates the selected configuration c. At items 10, 11, and 12, the SL Tx1 WTRU communicates with SL Rx1 using T-F resource ‘c’ for the travel in direction D3. There is no collision of transmissions between SL Tx1 and SL Tx2 while both are traveling in direction D3 because different T-F resources are used between the two transmitting WTRUs. Meanwhile, as depicted in items 16, 17, and 18, the communication between SL Tx2 and its receiver SL Rx 2 has not changed. The SL Tx2 is transmitting in direction D3 using T-F configuration ‘a’.

In a further discussion of FIG. 12, at item 5 and 6, SL TXs receives a periodic resource configuration including multiple resource set configurations containing multiple direction specific periodic resource configurations. Each configuration may include one or more of the parameters including configuration identity (e.g., id), time-frequency resource allocation, periodicity, total time duration, etc. The mapping of each resource set to a transmission direction and Tx-location (or zone) may also be part of the configuration. As an example (not shown in FIG. 12), in a particular zone, a resource configuration 1 for transmissions in a quadrant 1, resource configuration 2 for transmissions in a quadrant 2, and so on may be used. More elaborate configurations and mappings for different angular ranges can be easily obtained at the gNB and communicated to the SL Tx.

Along with each SL Tx (SL Tx1 1220 and SL Tx2 1240) receiving a periodic resource configuration at 5 and 6, resource configurations and mappings may be dependent upon SL Tx location (or zone) and the direction of transmission; different resources may be configured for different zones (it may be similar to location based resource pool allocation in SL design), and if the SL Tx changes the location (or zone) or/and its direction of transmission, the SL Tx activates the suitable configuration as per the configured mapping.

Optionally the gNB can configure that the SL Tx informs the gNB when it activates a new periodic resource configuration following the change in location/direction of transmission. Uplink resources, e.g., periodic resources over the uplink control channel, may be configured for the WTRU to send an indication of change in the active configuration to the gNB. The indication may thus be transmitted using an RRC message. Alternatively, the WTRU may send a SR to allocate uplink resources when the WTRU activates a new configuration, and the allocated uplink resources may be used by the WTRU to send an indication of change in the active configuration to the gNB. The indication may contain for example the configuration ID of the newly activated configuration. In a different approach, some of the bits in a PUCCH can be used to convey the indication of active resource configuration, effectively using physical layer signaling to convey the information. Alternatively, the WTRU may send an UL MAC-CE message to send the indication of change in the active configuration to the gNB. The indication may contain the ID of the configuration selected by the WTRU for the activation.

As presented hereinabove, the term “the cone of operation” (or “directional information”) of a signal represents the area where this signal can be received with signal energy higher than a threshold. This threshold can be the minimum signal energy which allows decoding this signal or it can be the minimum interference energy which is acceptable when this signal appears as interference at a non-intended receiver. Nevertheless, this threshold can be programmable and different suitable values for this threshold can be agreed upon prior to operation or configured as part of the configuration. This cone of operation is in the shape of a conic beam transmitted by a sidelink device. Thus, the parameters defining this cone of operation include the location of the SL transmitting device, the direction of transmission (or direction of SL receiving device from the transmitting device) and the range of transmission (which is dictated by transmission power and the channel impairments). The cone of operation can also be defined more precisely considering the antenna radiation patterns (side lobes and respective antenna gains) and the side information about the terrain/maps/blocking objects etc. In essence, the cone of operation associates an area to a transmitted signal or time-frequency transmission resource where this signal can be received with a non-negligible signal energy, and thus may cause harmful collision if the same time frequency resource is used by another device within its cone of operation. In one example, a cone of operation may include a set of beams. If the beams are associated to directions, the beams can be used as one of the attributes defining the cone of operation, in addition to the other parameters that the cone of operation already has.

With this terminology in place, the scheme for SL configured grant resource allocation may include the gNB configuring multiple resource sets to a SL transmitting device where each resource set is mapped to a given cone of operation. Typically, a cone of operation may include a location, position, and range that is provided along with a configured resource allocation by a gNB to a WTRU. Thus, the gNB configuration includes multiple resource sets and the mapping/association of each resource set to a cone of operation. The WTRUs will estimate their cones of operation according to the standard procedure, which could use some programmable parameters. In addition, each SL Tx can estimate its own cone of operation (estimated cone of operation may include an estimated location, position, and range to be used by the SL Tx). The SL transmitting device initially activates a resource set suitable for its estimate of current cone of operation according to the resource mapping (multiple possible resource allocation configurations with the mapping providing the association of a resource set to a cone of operation) provided by the network. The determination of cone of operation using suitable/selected parameters such as Tx location, Rx location, transmit beamwidth, transmission power etc., can be part of the configuration received from the gNB. In a different compatible approach, the determination of cone of operation can be a standard computation, a formula for example, known to all SL devices. When the cone of operation that a WTRU is using for D2D communication changes, which may happen due to one of the following individual elements or a combination of the following: (i) mobility of SL Tx, (ii) mobility of SL Rx, (iii) change of beam direction or beamwidth as part of beam management procedure, (iii) change of range of cone of operation due to transmission power update, then the SL transmitting device may select a suitable resource determined by the mapping from the WTRU estimated cone of operation to one of the other the configured resource configuration sets received by the WTRU. Suitable thresholds and granularities for estimated cone of operation determination and update are used to avoid too many updates or too few updates. As part of the configuration, the SL transmitting device may be configured to provide the indication of its active resource set to the gNB whenever it makes an update in view of its updated cone of operation. This indication to the gNB can be in the form of a RRC message. To make this indication faster, it can be transmitted in the form of a MAC-CE message.

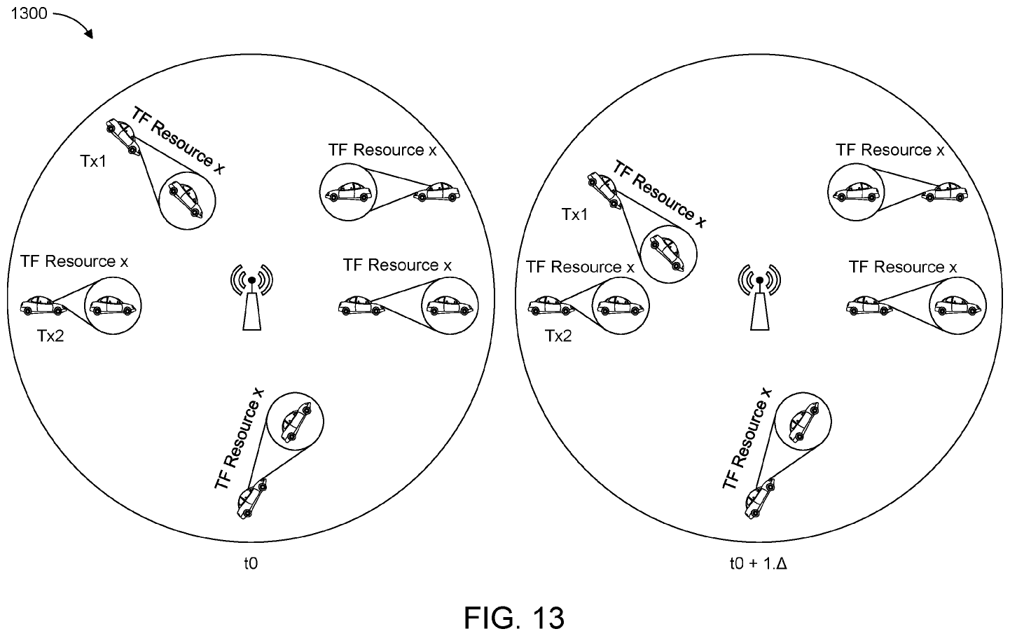

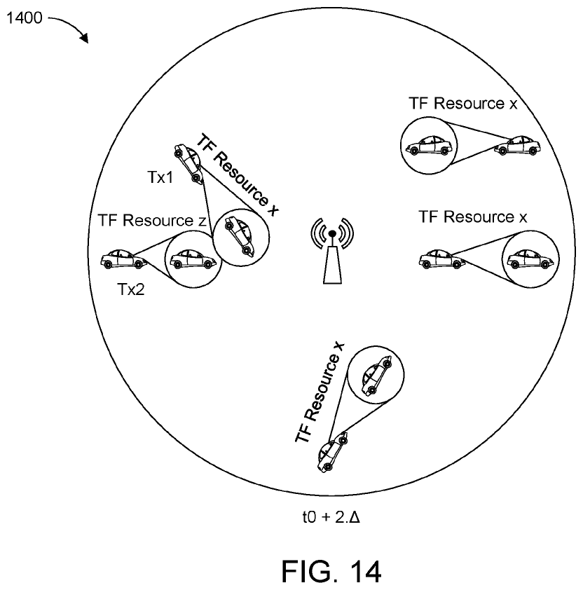

FIG. 13 shows an example layout 1300 with a gNB in the middle performing SL allocations for the SL devices in the vicinity. For each communicating pair, its relevant cone of operation is displayed. This figure shows two snapshots taken at time t0 at time t0+1.Δ where Δ represents a positive time interval. Of particular interest are the two pairs of SL devices in the left side, where the transmitting devices denoted as Tx1 and Tx2 are transmitting to their respective receivers using the same periodic resource set x. At time t0+1.Δ, the snapshot on the right-hand side of this figure, due to mobility, the cones of operation, as estimated by the SL Txs themselves, have come very close to each other for these two transmitters. The two transmitters keep estimating their cone of operation and in case of change will update their active CG resource set as per the mapping provided by the gNB. This is shown in FIG. 14 depicting the snapshot 1400 at time t0+2.Δ, where Tx2 has activated a different resource set ‘z’ as per the configuration mapping received from the gNB.

To achieve very aggressive frequency reuse for SL resources as discussed herein, the gNB may allocate multiple resource configurations (along with the resource configuration mapping to different cones of operation) to multiple SL WTRUs for their configured grant transmissions. The key to avoid the collisions is the randomization in the mappings provided to different SL Tx(s) to map their cones of operation to resource sets. This disclosure uses the word “randomization” to highlight the fact that the mapping/association of resources to cones of operation is different for different WTRUs, though in practice, this randomization can be result of scheduling algorithms running at the gNB considering many WTRU features, network features, and system parameters. Here, in one example, a comparison between an estimated cone of operation (an expected cone of operation as estimated by the WTRU) with a current cone of operation (one of the resource sets in which the WTRU is currently functioning) may be made by the WTRU to determine if a change to another resource set that is possibly more compatible with the estimated cone of operation. Thus, for an identical cone of operation where receivers of two or more transmissions are susceptible to receiver interference from the Tx of other transmissions, the gNB provided randomized mapping of cones of operation to CG resource sets will lead the transmitters to choose different resources and hence the interference will be avoided. The relative configuration of these SL WTRUs is such that for a given/configured cone of operation, they are configured with different/disjoint resources. This implies that with change of a WTRU location or/and change in transmission direction leading to potential collisions, the WTRUs will switch to appropriately configured resources, and will not have interfering situations with each other. The SL devices may track their intended transmission direction through message exchanges, transmission of reference signals, and measurements reports. The SL Tx may transmit reference signals, for example multiplexed within the control (e.g., PSCCH) or/and data channels (e.g., PSSCH) of the CG transmissions to its SL Rx. The SL Rx may make measurements (e.g., RSRP, RSSI, or/and SINR) using the reference signals transmitted within the control or/and data channel. The SL Rx may report measurements back to the SL Tx. Such measurements may be used by the SL Tx to determine if the transmit direction or/and the resources need to be updated for the future transmissions to the SL Rx. For example, in case of high interference observed by the SL Rx, the SL Tx may determine to change the direction/resource of the transmission to the SL Rx.

As a simple example of the proposed scheme, the gNB provides periodic resources r1, r2, and r3 and mapping of each periodic resource to cones of operation c1, c2, and c3. Suppose WTRU1 is provided with the following mapping as part of its configuration: r1=>c1, r2=>c2, r3=>c3. A different WTRU, WTRU2, is configured with the same resource sets, r1, r2 and r3, but provided with the following mapping, r2=>c1, r3=>c2, r1=>c3. The cones of operation computation can be a standard procedure using one or more of the parameters like direction of transmission, location of Tx/Rx, beamwidth, transmission range, transmission power etc.). In a compatible design, the gNB can configure some parameters used in the cone of operation calculation, or it can configure details of different cones of operation as part of the configuration. At the WTRU side, they will estimate their cones of operation and select suitable resource set as per their configuration received from the gNB. Suppose WTRU1 and WTRU2 estimate their cones c1 according to the standard calculation. WTRU1 will choose resource r1, while WTRU2 will choose resource r2, thus avoiding the collisions.

This solution results in higher occasions of frequency re-use without collisions. The important technical advantage in this scheme is the fact that the SL devices do not need to transmit location (or zone) or/and direction information to the gNB, or a composite cone of operation, and the gNB does not need to track or update the resource configurations by explicit signaling to the SL devices. This results in a very lean approach, and the minimal signaling and tracking overhead.

### Signaling for Mapping Configuration

Multiple configurations can be indicated to a SL WTRU. Each configuration may include one of more of the parameters including configuration identity (e.g., id), time-frequency resource allocation, periodicity, total time duration, etc. The transmit-directions and locations (or zones) may be known either by specification or may be configured as part of the configuration. One suggested suitable/selected parameter which combines the locations and the direction of transmission is the cone of operation as defined earlier. It can incorporate locations, direction of transmission, transmission power and beamwidth. In addition, the cone of operation can be enhanced with the antenna radiation patterns and gains for different side lobes. The mapping between different resource configurations and cones of operation is provided as part of the configuration for the periodic resources. The transmit directions can be in the form of angles with respect to the cardinal directions, or they can be in the form of relative directions with reference to the direction between the SL Tx and the gNB. The mapping can be in the tabular form or in the form of an equation. This can also incorporate transmit location (or zone) with suitable/selectable granularity. One form can be set to use the SL Tx location as SL Zone ID where the SL Tx is located.

The gNB Control of the SL Transmission Power for CG with Direction Specific Resource Set Configuration

In a compatible design, the gNB may provide a SL Tx an indication of transmit power in addition to the periodic time frequency resource configuration for each of the direction of SL transmissions. There could be a single transmit power indication associated to all configured direction specific resources. A SL Tx UE will then use this transmit power indication no matter which resource is activated. Additional flexibility can be obtained by associating a transmit power indication with each direction specific resource configuration. This transmit power can be the actual transmit power to be used for the SL transmission, or it can be an upper bound (e.g., maximum transmit power) which a SL Tx should not cross while transmitting over this SL allocated resource. By providing an indication of SL transmit power, be it the transmission power or the limit on the transmit power, the gNB can control in a fine grain manner the range or cone-of-operation for the SL transmission from a given SL Tx. This allows the gNB scheduler plan the higher occasions of frequency reuse in a systematic manner by ensuring that the transmissions from certain SL Txs will stay within certain zones dictated by the SL transmit power indication.

### Example Third Embodiment for a Periodic CG Resource Allocation from a gNB

This third example embodiment describes a method performed by a SL WTRU to request periodic/configured-grant resource allocation from the gNB uses a cone of operation feature as described hereinabove. A SL Tx sending the CG resource request to the gNB may take the following actions:
Receiving a grant from the gNB containing multiple configurations of periodic time-frequency resources each with a separate identification wherein a mapping is provided as part of the configuration, the mapping associating each configuration with a cone of operation for this SL Tx;
Selecting a suitable resource configuration as a function of its current estimate of a cone of operation;
Performing transmission (or other communication) with a SL Rx using the selected resource configuration. The above example embodiment may include:
The SL TX may include its zone or location information within the CG resource request to the gNB.
The SL Tx tracks its cone of operation which in turn may include any combination of the following parameters: Tx location, Rx location, transmission direction, transmission power, and transmission beamwidth.
The periodicity for tracking the cone of operation is part of the configuration.
The cone of operation is determined using the configured formula.
The cone of operation is determined using the known/configured formula where some of the parameters may be configured as part of configured grant configuration.
When the newly determined cone of operation is mapped to a different resource (set) configuration, the SL Tx will de-activate the current configuration and will activate the resource configuration associated to newly determined cone of operation as per the configured mapping.
The SL Tx may track and update the direction of transmission from the measurement reports received from the SL Rx.
On the change in SL Tx location (or zone) or/and direction of transmission, the SL Tx may select or activate another resource configuration (if any) associated with the new SL Tx location (or zone) or/and direction of transmission from the multiple resource configurations.
On the change in active resource configuration, the SL Tx may send an indication carrying the identification of the most recently selected active resource configuration to the gNB.
The indication carrying updated active resource configuration may be transmitted using a RRC message.
The indication carrying updated active resource configuration may be transmitted using MAC-CE message.
With multiple direction specific resource configurations provided, WTRU receiving an indication of transmit power to be applied for the SL transmission for each resource configuration.

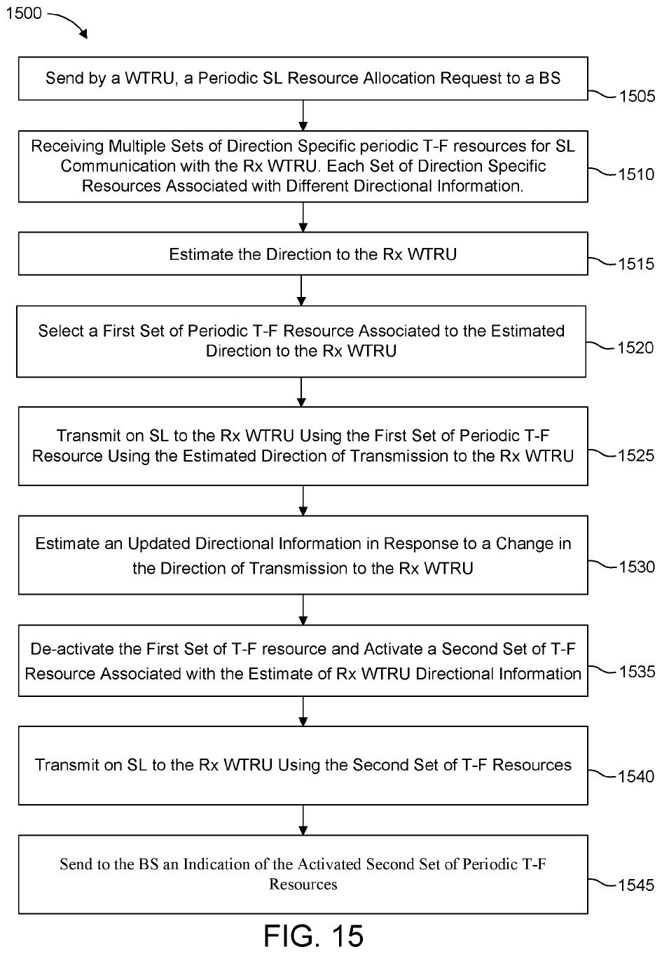

FIG. 15 depicts an example flow diagram of a method performed by a transmit WTRU to receive and utilize resource configurations in accordance with methods described hereinabove. In FIG. 15, at 1505, a transmit WTRU, such as a SL Tx as described herein sends a resource allocation request to a base station. Such a request may be sent from the WTRU to a base station, such as a gNB via a Uu reference interface or other suitable communication interface between a WTRU and the base station. At 1510, the WTRU receives a resource allocation grant from the base station containing multiple resource configurations. The Tx WTRU receives configuration information of multiple sets of direction specific periodic T-F resources for SL communication with the Rx WTRU. The multiple sets of direction specific periodic resources are associated with different directional information for SL transmission. Here, each received resource configuration from the base station may include an associated indication of a configured location, direction, beamwidth, and/or range.

At 1515, the WTRU may estimate the direction to the Rx WTRU. This estimate of direction may include an indication of an estimated location, direction, beamwidth, and/or range. This estimate is made based, in part, on an estimated trajectory of the WTRU, the receiver, or conditions that may affect a reliable communication link between the WTRU, such as the SL Tx, and another WTRU, such as a SL Rx. At 1520, the WTRU selects one (a first set) of the multiple received resource configurations based on the estimate of direction of the Rx WTRU. This estimate may include an estimated location, direction, and range that was estimated/determined/predicted by the WTRU. Preferably, the selected one (first set) of the multiple received resource configurations has an associated location, direction, beamwidth, and range that is compatible with the estimated location, direction, and range determined by the WTRU.

At 1525, after selection of a resource configuration (a first set) that can be used to achieve a D2D communication with a receive WTRU based on the estimated direction of transmission, then the WTRU may transmit or receive a communication with the Rx WTRU using the selected resource configuration set. The Tx WTRU can transmit on SL to the Rx WTRU using the first set of periodic T-F resource using the estimated direction of transmission to the Rx WTRU. At this instance, the WTRU has selected a current resource configuration (a first set) that is compatible with its communication needs for D2D communication with a Rx WTRU. This may conclude the steps need to establish a D2D communication between a Tx WTRU and a Rx WTRU. However, under some conditions, such as mobility of either or both the Transmit WTRU or the receive WTRU, a new resource configuration may be needed.

In FIG. 15, at 1530, the Tx WTRU may estimate updated directional information in response to a change in the direction of transmission to the Rx WTRU estimated by the Tx WTRU. A new resource configuration may be selected from the received multiple resource configurations that may become more compatible with an estimated cone of operation or “directional information” (including estimated location, direction, beamwidth, and/or range) determined by the transmit WTRU. In that instance, it may be desirable to apply the newly selected resource configuration.

At 1535, the WTRU may de-activate a current resource configuration (the first set) and activate the new resource configuration (a selected second set) associated to the estimate of the updated directional information to the Rx WTRU. This action may allow the transmit WTRU to better accommodate a change of the cone of operation (directional information) to avoid any interference with other D2D SL pairs operating in the same geographic area. At 1540, the Tx WTRU can transmit on SL to the Rx WTRU using the selected second set of T-F resources. At 1545, the Tx WTRU may send to the BS an indication of the activated second set of periodic T-F resources. This notifies the base station of the transmit WTRU use of the new resource configuration.

### SL Devices Providing Transmission Direction Indication for Dynamic Grant SL Transmissions

This embodiment proposes a novel mechanism which enables a high occurrence of frequency reuse for SL resources when a SL Tx is requesting aperiodic SL resources. As used herein, a dynamic grant may be defined as a grant that is specifically requested by a SL Tx for a SL transmission. A SL Tx requests the aperiodic resource in the form of a dynamic scheduling request (SR). This is achieved by transmitting a scheduling request to the gNB. This embodiment proposes that the SL Tx indicates its intended transmission direction information as part of SL resource request to the gNB. This allows the gNB to perform a higher occurrence of frequency reuse for SL transmissions exploiting the fact that these transmissions will be highly directional and making use of the transmission direction indication provided by the SL Tx.

If a SL Tx sends the limited information of its intended direction to the gNB, the gNB can schedule the same sub-channel(s) in the proximity to other users transmitting in non-overlapping directions. Direction information indication enables such use given the fact that the gNB already has the information about the location of transmitters requesting SL resources as these users will be in RRC_CONNECTED state and will be exchanging control/data messages with the gNB. This will lead to a higher occurrence of frequency reuse resulting in higher system efficiency.

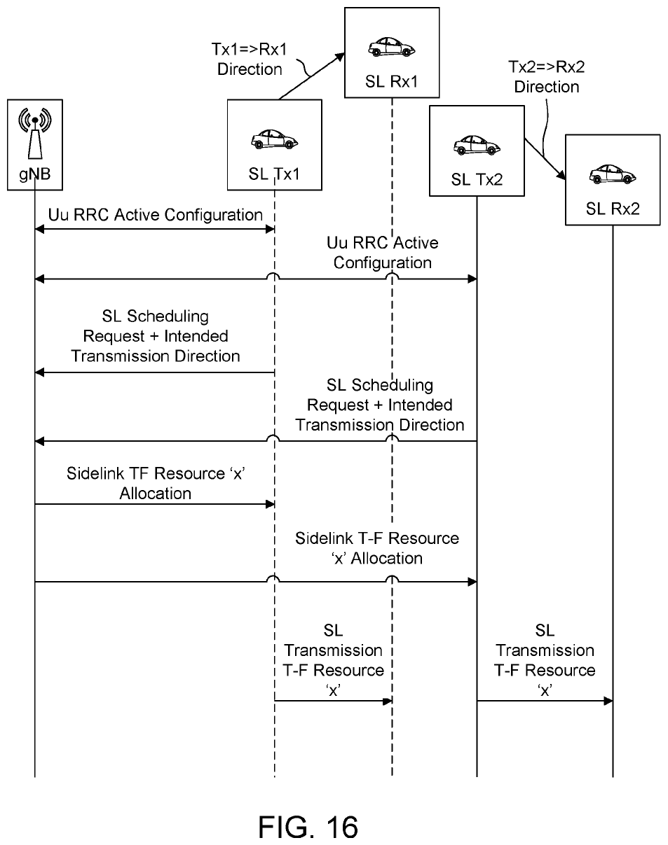

FIG. 16 shows an example scenario with two communicating pairs of SL devices. The two SL Tx(s) are in RRC_CONNECTED state with the gNB and are requesting dynamic grant-based SL resources from the gNB. As per the proposal, SL Tx1 and SL Tx2 indicate their intended transmission direction to the gNB while transmitting scheduling requests. The received direction information indication combined with the gNB knowledge of SL Tx(s) location allows the gNB to well estimate the area where their respective transmissions will be received. Making use of this information, the gNB estimates that these two SL transmitters, SL Tx1 and SL Tx2, will not interfere with each other, and the gNB can allocate the same time-frequency resource ‘x’ to both Tx(s) for their respective SL transmissions, leading to an increase in the system spectral efficiency.

### Encoding of Direction Information

Following sub-sections provide the techniques on how a SL Tx can provide the indication of its intended direction of transmission to the gNB.

### Direction Against an “Absolute Reference”

The direction information may be provided with respect to an absolute reference direction, e.g., cardinal North. Absolute directions in terms of degrees, minutes, seconds with respect to a global reference, e.g., compass bearing, may be provided.

Direction with Reference to the gNB Position

In one design, the SL Tx may encode the intended transmit direction information against the gNB location. Thus, the direction information may include the angle at the SL Tx between (i) a line joining SL Tx and the gNB, and the intended transmit direction from SL Tx to the intended SL Rx. As WTRUs will continuously track the signals from their gNB to properly receive and transmit with them, they will have continuous tracking of gNB direction. This allows easy encoding of intended transmission direction at the SL Tx. Similarly, as the gNB will be tracking the SL Tx with which it is exchanging messages in RRC active state, the gNB can easily decode and interpret the received direction information from the SL Tx.

For example, direction relative to the angle of arrival of the downlink SS/PBCH block selected by the WTRU (e.g., for Random Access Channel association and transmission). For the target direction of WTRU's SL transmission, both azimuth (e.g., horizontal) and elevation (e.g., vertical) angles relative to the angle of arrival of the selected downlink SS/PBCH block (e.g., in terms of angular units such as degrees, minutes, seconds) may be indicated to the gNB.

### SL TX/Rx Zone Indication to the gNB

In another design, the SL Tx may provide the indication of its intended transmission direction by providing the zone identity (ID) of the SL Rx. SL Tx may have the knowledge of SL Rx zone ID. Otherwise, it can request this information from its intended SL Rx while setting up the communication. A SL Tx may derive its SL zone ID as per the SL configuration. The SL Tx may send the Rx zone ID, and potentially its own zone ID to the gNB. SL Tx zone information may be optional as the gNB has access to SL Tx's location information through other mechanisms such as estimating the signals transmitted by SL Tx on Uu interface.

### Direction Indication Over PHY Layer Signaling

In another compatible design, the indication of transmission direction can be transmitted using PHY layer signaling. This can be achieved in a variety of ways as discussed in the following:

### Indication Transmitted as Part of the Scheduling Request

The indication of transmission direction can be transmitted as part of the scheduling request when a SL Tx is requesting SL resources from the gNB by transmitting an SR. A SR is part of uplink control information (UCI) which is typically transmitted over physical uplink control channel (PUCCH). 5G NR has specified different PUCCH formats to accommodate different amounts of data to be carried PUCCH for 1- or 2-bits vs PUCCH formats for more than 2 bits), to accommodate different latency requirements (short PUCCH or long PUCCH) etc. A suitable quantized form of direction indication can be transmitted along with SR bits to indicate the intended direction of transmission to the gNB. When there is an overlap of PUCCH resource with physical uplink shared channel (PUSCH), 5G NR has defined the prioritization in certain cases and has defined which physical channel to be prioritized in case of overlap between PUCCH and PUSCH resource. The prioritization may result in a WTRU transmitting only PUCCH, only PUSCH, or the case when UCI is multiplexed over PUSCH. In case prioritization leads to the rule of UCI multiplexed over PUSCH, UCI may be encoded separately from PUSCH data and at the end UCI is multiplexed over PUSCH resource according to the specified rules.

This scheme has the advantage that a SL Tx may be communicating with multiple SL Rxs, and each time, the SL Tx sends an SR for a given Rx, the SL Tx can indicate the intended direction of transmission for this Rx to the gNB as part of the SR. The direction of transmission may need to be quantized heavily as SR is only a single bit of information, so adding large number of bits for the sake of direction indication will result in increased load for PUCCH. For example, instead of single bit, if two bits may be used for sending a SR with the intended direction of transmission information, e.g., 00 SR for transmission in Direction 1 (e.g., North), 01 SR for transmission in Direction 2 (e.g., East), 10 SR for transmission in Direction 3 (e.g., South), 11 SR for transmission in Direction 4 (e.g., West). More bits may be used more granular direction information.

When a SL Tx sends an SR to request SL transmission resources and receives a grant with the allocated resource information, after the transmission over the allocated resources, SL Tx may receive a negative acknowledgement (NACK) (e.g., as a SL HARQ feedback) from the SL Rx for its transmission. In that case, SL Tx forwards HARQ feedback NACK to the gNB over the Uu interface. Upon receiving NACK, the gNB schedules the SL resources for the re-transmission of the initial transmission. In a proposed scheme, when the gNB receives a NACK, the gNB may use the same direction of transmission for the SL Tx as communicated while sending SR.

When the gNB is providing proactive grants for a SL Tx, the SL Tx direction information may not be available or may be outdated. Similarly, the direction for re-transmission may have changed due to mobility when the gNB schedules re-transmission resources based upon NACK received from a SL Tx. This may lead to some collisions if the gNB does very high occurrence of frequency reuse of T-F resources. One possibility to avoid collisions could be that the gNB does “moderate” frequency reuse while sending proactive scheduling grants and allocating re-transmission resources. The readers will appreciate that the frequency reuse means the simultaneous allocation/usage of T-F resources for different transmissions.

### Indication as Part of the Scheduling Request for Transmission Resources and as Part of ACK/NACK for Re-Transmission Resources

In this method, the indication for the intended direction of transmission can be transmitted as part of the scheduling request and SL HARQ feedback transmitted over Uu. When a SL Tx is requesting the SL transmission resources from the gNB, it can transmit the intended direction of transmission along with SR in a suitable quantized form. Upon receiving the HARQ feedback response from the intended recipients of the SL transmission, a SL Tx may be sending the SL HARQ feedback to the gNB if configured over Uu link. As a SL NACK for a transport block transmitted over Uu works as a request for SL re-transmission resource for the same transport block, a SL Tx may send the indication of intended direction of transmission as part of the HARQ feedback. As re-transmission resource is only required in case of NACK, only NACK information needs to be extended to incorporate direction indication. In one example, if a SL Tx sends 0 for NACK and 1 for ACK for a legacy system and now the SL Tx it needs to transmit 1 bit (as an example) for direction indication, the SL Tx can transmit the following enhanced HARQ feedbacks:

| | |
|---|---|
| 00 | NACK with Direction 1 |
| 01 | NACK with Direction 2 |
| 10 | NACK with Direction 3 |
| 11 | ACK. |

The direction indication transmitted with HARQ feedback can be the updated direction indication as a whole, or it can be the change in the direction with respect to the previous indication direction of transmission.

This scheme has the advantage that a SL Tx may be communicating with multiple SL Rxs, and each time, the SL Tx sends an SR or NACK for a given Rx, the SL Tx can indicate the intended direction of transmission for this Rx to the gNB as part of the SR/NACK. The direction of transmission may need to be quantized heavily as SR and NACK for a given transport block are only a single bit of information, so adding large number of bits for the sake of direction indication will result in increased load for PUCCH.

When the gNB is providing proactive grants for a SL Tx, the SL Tx direction information may not be available or may be outdated. This may lead to some collisions if the gNB does very high occurrence of frequency reuse. One possibility to avoid collisions could be that the gNB does “moderate” occurrences of T-F resource reuse while sending proactive scheduling grants to SL transmitting devices.

### Indication as a New Element of UCI

In the previous approaches for physical layer indication of intended direction of transmission, direction of transmission changes the number of bits for SR and SL HARQ feedback transmitted over Uu interface. This involves some complexities as different PUCCH formats for different SR/HARQ feedback may be required. For the HARQ feedback, the code book design also gets impacted.

To avoid changing the design for SR and HARQ feedback from the legacy, this section proposes a novel method where the intended direction of transmission may be transmitted as a new information element of UCI. Thus, a suitable number of bits can be used to provide the transmission direction indication to the gNB. The rules can be specified as to when this information needs to be transmitted and how to associate the intended direction and SR when a SL Tx may be communicating with multiple SL Rx(s) at the same time. One possibility can be to always transmit intended direction of transmission in UCI when either of SR or SL HARQ NACK feedback is transmitted over Uu in UCI. In addition to that the configuration can allow periodic transmission of direction indication to the gNB. A SL Tx can also transmit an indication of the SL Rx along with direction indication.

### Direction Indication Over MAC Layer Signaling

The indication for the intended direction of transmission can be transmitted using MAC Layer signaling. In one design method, the direction indication can be embedded with buffer status report (BSR) transmitted to the gNB informing the buffer status for the destination WTRU. This can be achieved by adding an optional field in the BSR MAC-CE indicating the intended direction of transmission.

A more elegant strategy can be to introduce a new MAC-CE which provides the indication of intended direction of transmission to the gNB. There could be a timer with which SL Tx WTRU may update the information to the gNB. In addition, a threshold can be part of the configuration where if the direction changes more than the configured threshold (e.g., configured by the serving gNB), a SL Tx WTRU will update the direction information to the gNB. The update to the intended direction of transmission can be in terms of absolute direction indication, or the update can be the change with respect to the previous indicated direction.

### Direction Indication Over RRC Layer Signaling

In this method, a SL Tx indicates its intended direction of transmission to the gNB over RRC signaling. In an example, this indication can be transmitted in RRC message as part of “SidelinkUEInformationNR” which carries “SL-TxResourceReq-r16”. “SL-TxResourceReq-r16” has the indication of SL Rx “sl-Destinationldentity-r16” to which a SL Tx is transmitting.

SL Tx sends the direction information in SL-TxResourceReq-r16 along with SL-DestinationIdentity. This can be easily achieved by adding an information field in the “SL-TxResourceReq-r16”.

This direction information may be assumed to be valid unless the WTRU updates the information. The update on the information can be by the same RRC message or it can be transmitted over PHY/UCI signaling (e.g., over the PUCCH or physical uplink shared channel (PUSCH)) as per the previous indication methods.

In a more efficient and dynamic approach, a hybrid direction indication strategy of RRC with lower layer signaling can be designed. In this design, a SL Tx can provide the initial direction indication to the gNB over RRC signaling and can then update this information over PHY (e.g., as part of the UCI over the PUCCH or PUSCH) or MAC signaling (e.g., as a MAC-CE message).

### Direction Indication Transmitted Over Multiple Layers' Signaling

A more accurate and more refined method of providing the direction indication from a SL Tx to the gNB could be in the form of multi-layer signaling. A hybrid design can be devised where the signaling is combined from different layers. As an example, initial direction indication can be transmitted over RRC layer signaling while indicating the transmission possibility toward a given SL Rx. As this message is transmitted over RRC, an accurate (e.g., more granular) direction information can be transmitted. This information can then be updated by providing the updated information on physical layer signaling as described previously. This physical layer updated information can be the change with respect to the original indicated direction to make it fit in smaller number of bits.

In another design, the original direction indication can be transmitted over MAC layer signaling, in a MAC-CE. This can be done e.g., by transmitting more bits in a new MAC-CE or with the BSR report. Then the updates for the same SL Rx are transmitted over physical layer signaling. These updates may refine or update the direction initially transmitted over MAC-CE.

In the same manner, a hybrid design of RRC, MAC and PHY layer signaling can be devised, where detailed direction indication is transmitted over RRC and MAC, and then updates may be transmitted over PHY signaling.

Variation with Cone of Operation for Dynamic Grant SL Transmission

As discussed hereinabove, the term “the cone of operation” of a signal represents the area where this signal can be received with a given signal energy. The term “directional information” may be used with equal meaning herein to “cone of operation”. With this terminology, a slight variation of the current embodiment can be as in the following: a SL Tx requests aperiodic resources from the gNB and sends along its current estimate of its cone of operation for its SL transmission. With the knowledge of cone of operation for this SL Tx, the gNB can do very high occurrence of frequency reuse for SL resources as it can estimate very well the colliding pairs. All the signaling techniques described earlier to indicate the intended direction of transmission, whether the signaling on a given layer as PHY/MAC/RRC or a hybrid signaling as a combination of RRC+PHY, MAC+PHY or RRC+MAC+PHY, can be used to convey the estimated cone of operation when a SL Tx is requesting the dynamic grant resource from the gNB.

In another compatible design, we can exploit the fact that the gNB has the information about the SL Tx location (SL Tx being in RRC active mode). Thus, the SL Tx can provide the feedback to the gNB which allows the gNB to compute the cone of operation for this SL Tx. The SL Tx can provide one or a combination of Rx location, transmission direction, transmission power, beamwidth to the gNB. Combining this feedback with the most recent location estimate for a given SL Tx, the gNB determines the cone of operation for this SL Tx. Based upon this cone of operation, and the scheduler's knowledge for different sidelink devices, the gNB scheduler can do very high occurrence of frequency reuse by scheduling the same time frequency resource for multiple pairs whose cones of operation are either non-overlapping or don't harm the quality of communication.

### The gNB Control of the SL Transmission Power for Dynamic Grant SL Transmission

In a compatible design, the gNB having received the direction indication (which can include a direction or cone of operation indication in a suitable format) may provide a SL Tx an indication of transmit power for its sidelink transmission in addition to the time frequency resource allocated for its sidelink transmission. This transmit power can be the actual transmit power to be used for the SL transmission, or it can be an upper bound (e.g., maximum transmit power) which a SL Tx should not cross while transmitting over this SL allocated resource. This indication of SL transmit power can be carried in the downlink message (e.g., DCI) allocating the SL time frequency resource for the SL Tx.

By providing an indication of SL transmit power, be it the transmission power or the limit on the transmit power, the gNB can control in a fine grain manner the range or cone-of-operation for the SL transmission from a given SL Tx. This allows the gNB scheduler plan the higher number of occasions of frequency reuse in a systematic manner by ensuring that the transmissions from certain SL Txs will stay within certain zones dictated by the SL transmit power indication.

### The gNB Updating the Number of Retransmissions and the SL Transmission Power for Dynamic Grant SL Transmission

In a compatible design, the gNB may provide the indication of the SL transmission power and the number of re-transmissions for the SL transport block. The number of re-transmissions may initially be a number as part of the SL configuration, or it can be a specific number of re-transmissions requested by a SL Tx to reach a certain level of QoS target. The reason for the update is that the gNB may decide to limit the SL transmission power to a certain degree to enable higher occurrence of frequency (T-F resource) reuse without degrading the transmissions carried over the same time-frequency resource. The limits imposed on the SL transmit power reduce the interference with the neighboring transmissions but may also degrade the detection quality at the desired recipients. To compensate, e.g., especially for the applications where high reliability is needed, the gNB may schedule additional re-transmission(s) for the same transport block which ensures higher reliability of the transport block at the target recipient(s).

By providing an indication of SL transmit power and the number of re-transmissions, the gNB can control the trade-off of transmission power and number of re-transmissions where the a given choice of transmission power lets the gNB choose appropriate frequency reuse for the SL resources. Downlink message (e.g., DCI) which provides the SL allocated resource to a SL Tx may need to be appropriately updated by introducing the indication of transmit power and the number of re-transmission resources.

### The gNB Scheduling Multiple Direction Specific SL Transmission Resources for Dynamic Grant SL Transmission

In a design compatible to the previous proposals, the gNB, having received the scheduling request from a SL Tx along with an indication of intended direction/cone-of-operation for its SL transmission, can provide multiple SL resources to a SL Tx. Multiple SL resources are associated to different SL transmission directions. They can incorporate the change of direction of SL transmission due to various factors e.g., the mobility of SL Tx, SL Rx and the change of location between the time while scheduling request was made to the time of the actual SL transmission etc. The number of direction specific resources provided by the gNB can be part of the configuration or pre-configuration. The mapping of different SL transmission resources to different transmit directions can be part of the specification or can be part of pre-configuration. Additional resources may be associated to the directions which are neighboring to the direction indicated by the SL Tx to the gNB. In one specific example, the gNB can provide three direction specific resources as part of SL grant. One resource can be associated to the direction indicated by the SL Tx. The other two resources could be associated to two neighboring directions on either side of the indicated direction.

In a variation of this design, the number of direction specific resources can be indicated dynamically by the gNB. The gNB can consider the user mobility and the network dynamics to provide a given number of direction specific resources. The mapping of direction specific resources to suitable directions, e.g., neighboring to the SL Tx intended direction of transmission, can be part of the configuration or it can be indicated as part of dynamic signaling (e.g., in the downlink message, e.g., DCI, containing the resource allocation, sent by the gNB after receiving a SR) from the gNB to a SL Tx.

### Applicability to Multicast or Groupcast Sidelink Transmissions for Dynamic Grant SL Transmission

In a variation, the proposed innovation can be applied to multicast or groupcast sidelink transmissions. For sidelink systems operating at very high T-F resource reuse occasions, a SL Tx may not be capable of transmitting in multiple directions where it should transmit for groupcast transmission. This may be the result of users spread in various directions which form a group of communicating sidelink devices. This may imply that a SL Tx will perform multiple sidelink transmissions in different directions in a TDMA manner. In one example, dedicated SR resources may be configured to request for multicast/groupcast SL transmission resources. In another example, common SR resources may be configured for unicast and multicast/groupcast transmission resources, and a specific indication (e.g., specific one-bit field) may be configured to indicate whether the request is for unicast or multicast/groupcast SL transmission. A SL Tx will provide an indication of the directions to the gNB where it should transmit to achieve a groupcast transmission. This may require special signaling and quantization for direction indication suitable to group specific aspects and multiple directions which might need to be indicated. One example design can be where a SL Tx can provide a combination of multiple narrow directions and/or wide directions. For example, a wide direction indication may cover a wide beam/angular area for example, 90 degrees of angular region, whereas a narrow direction indication may cover a narrow beam/angular area for example, 30 degrees of angular region. The wide direction indication can cover the cases where the group members may be in multiple neighboring directions with reduced signaling overhead. This indication can also be provided by providing the direction indication covering the directions where no group member is present and thus no transmission is needed in these directions. Having received the direction indication for the groupcast transmission, the gNB can provide the allocation of time-frequency resources which allow covering the directions of the groupcast transmissions. In one example, the WTRU may indicate a wide direction with an indication of number of transmissions/receivers. The gNB may use the information of number of transmissions/receivers to allocate the enough number of resources. The gNB can provide multiple transmission resources for SL Tx transmission in different directions, e.g., where resources for different directions may be distributed over the time. This allows the gNB scheduler flexibility to achieve higher T-F resource reuse. The association of transmission resources to the transmission directions can be part of the pre-configuration, e.g., in a special sequence, or it could be provided as part of the dynamic grant transmitted by the gNB.

### Example Embodiment—Unicast Transmission for Dynamic Grant SL Transmission

An example embodiment describing a method performed by a SL WTRU to request aperiodic/dynamic-grant resource allocation for a unicast SL transmission from the gNB may be as follows. A SL Tx WTRU may send a dynamic grant resource request and a direction indication for the intended transmission to the gNB, the SL Tx WTRU may take the following actions:
Receiving indication of multiple time-frequency resources from the gNB and the directions to which these time-frequency resources can be used for the SL transmission;
SL Tx uses the most recent estimate of intended direction of transmission to choose a suitable resource among the multiple received resources; and
SL Tx performing transmission to its SL Rx(s) using the selected time-frequency resource.

The above example embodiment may include:
The direction information indication may be provided with respect to an absolute reference direction, e.g., cardinal North, or may be provided in terms of degrees, minutes, seconds with respect to a global reference, e.g., compass bearing.
The direction information indication may be provided relative to the angle of arrival of the downlink SS/PBCH block of the gNB selected by the UE, where both azimuth (e.g., horizontal) and elevation (e.g., vertical) angles relative to the angle of arrival of the selected downlink SS/PBCH block (e.g., in terms of angular units such as degrees, minutes, seconds) may be indicated to the gNB.
The direction information indication may include a SL Rx zone ID.
The SL Tx may track the direction of transmission from the measurement reports received from the SL Rx.
The SL Tx may send the direction indication over RRC layer signaling.
The SL Tx may send the direction indication over MAC layer signaling. This could be done in the form of a MAC-CE. The information can be embedded in an existing MAC-CE such as BSR or a new MA-CE can be designed to carry this indication.
The SL Tx may send the direction indication over PHY layer signaling combined with SR.
The SL Tx may send the direction indication over PHY layer signaling combined with SR and SL HARQ feedback.
The SL Tx may send the direction indication over PHY layer signaling which can be transmitted over UCI as a new information.
The SL Tx may send the direction indication as a hybrid design with multi-layer signaling combined any of the above-mentioned approaches.
In the above example procedure, the SL Tx may compute its cone of operation which may include computation using a combination of (i) Tx location, (ii) Rx location, (iii) direction of transmission, (iv) transmission beamwidth, (v) transmission power and may use the cone of operation information to be sent to the gNB for resource allocation.
In the above example procedure, the SL Tx may indicate one or a combination of parameters including Rx location, transmission direction, transmission power, beamwidth to the gNB as part of dynamic grant resource allocation request which allow the gNB to compute the cone of operation for this SL Tx.
The gNB can provide an indication of SL transmission power. This SL transmission power can be the actual power with which SL Tx should transmit or it can be the upper limit which a SL Tx should not cross while transmitting over the allocated SL transmission resource.
The gNB can provide an indication of SL transmission power and the number of re-transmissions. This SL transmission power can be the actual power with which SL Tx should transmit or it can be the upper limit which a SL Tx should not cross while transmitting over the allocated SL transmission resource. The number of re-transmissions can be different from the one requested by SL Tx or understood from the pre-configuration.
The number of multiple direction specific dynamic grant resources can be part of the pre-configuration.
The number of multiple direction specific dynamic grant resources can be indicated dynamically as part of the SL grant.
The mapping of multiple direction specific resources to indicated direction and the neighboring directions can be part of the pre-configuration.
The mapping of multiple direction specific resources to indicated direction and the neighboring directions can be indicated dynamically as part of the dynamic grant signaling.

### Example Embodiment—Multicast/Groupcast Transmission for Dynamic Grant SL Transmission

An example embodiment describing a method performed by a SL WTRU to request aperiodic/dynamic-grant resource allocation for a multicast/groupcast SL transmission from the gNB may be as follows. A SL Tx WTRU may receive a configuration from the gNB containing one or more scheduling request resources to request the resources for multicast/groupcast SL transmissions, the SL Tx WTRU may take the following actions:
A SL Tx sending a dynamic grant resource request to the gNB for a multicast/groupcast SL transmission using a configured SR resource including a direction (angular area) indication, or/and number of transmissions;
Receiving multiple time-frequency resources from the gNB and an indication for mapping of multiple SL resources with the directions (within the requested angular area) to which these time-frequency resources can be used for the SL transmission; and
SL Tx performing transmissions to its multiple SL Rx(s) using the allocated time-frequency resources in the associated directions.

The above example embodiment, may include:
Common SR resources configured for unicast and multicast/groupcast transmission resources may be used with a specific indication (e.g., specific one-bit field) indicating that the request is for a multicast/groupcast SL transmission.
The direction information indication may be provided with respect to an absolute reference direction, e.g., cardinal North, or may be provided in terms of degrees, minutes, seconds with respect to a global reference, e.g., compass bearing.
The direction information indication may be provided relative to the angle of arrival of the downlink SS/PBCH block of the gNB selected by the UE, where both azimuth (e.g., horizontal) and elevation (e.g., vertical) angles relative to the angle of arrival of the selected downlink SS/PBCH block (e.g., in terms of angular units such as degrees, minutes, seconds) may be indicated to the gNB.
The direction information indication may include a SL Rx zone ID.
The gNB can provide an indication of SL transmission power for each of the groupcast SL transmissions. This SL transmission power can be the actual power with which SL Tx should transmit or it can be the upper limit which a SL Tx should not cross while transmitting over the allocated SL transmission resource.
The gNB can provide an indication of SL transmission power and the number of re-transmissions for each of the groupcast transmissions. This SL transmission power can be the actual power with which SL Tx should transmit or it can be the upper limit which a SL Tx should not cross while transmitting over the allocated SL transmission resource. The number of re-transmissions can be different from the one requested by SL Tx or understood from the pre-configuration.
The direction indication for groupcast transmission can be a combination of multiple narrow directions and wide directions.
The mapping of multiple SL resources allocated by the gNB for a groupcast transmission to indicated directions is part of the pre-configuration.

### gNB Configuration of Direction Specific SR/PUCCH Resources for Dynamic Grant SL Transmissions

### Main Idea and Signaling Diagram

This embodiment proposes a novel mechanism which allows high occurrence of frequency reuse for SL resources when a SL Tx is requesting dynamic grant-based SL resources. A SL Tx requests the aperiodic resource in the form of a dynamic grant. This is achieved by transmitting a scheduling request (SR) to the gNB.

The main idea in this embodiment is to enable high occurrence of frequency (T-F resource) reuse for SL transmissions while keeping the overhead minimal to enable this high occurrence of frequency reuse. This overhead is incurred in the form of direction tracking at a SL transmitting device, signaling and associated resource for direction reporting to the network/gNB. This embodiment proposes a novel design for SL dynamic grant where the gNB provides multiple scheduling request resource sets. Each SR resource set is mapped to a specific Tx location (or zone) and its direction of transmission. Each SR resource set may include one or more resources (e.g., periodic uplink resources over the PUCCH) associated to a specific Tx location (or zone) and its direction of transmission. The mapping of resources with location (or zone) and direction is also provided as part of SR resource configuration. Having received the SR resource configuration and mapping, the SL Tx will use the appropriate SR resource to request a dynamic grant-based SL resource for which its (SL Tx) location and direction of transmission match the configured mapping.

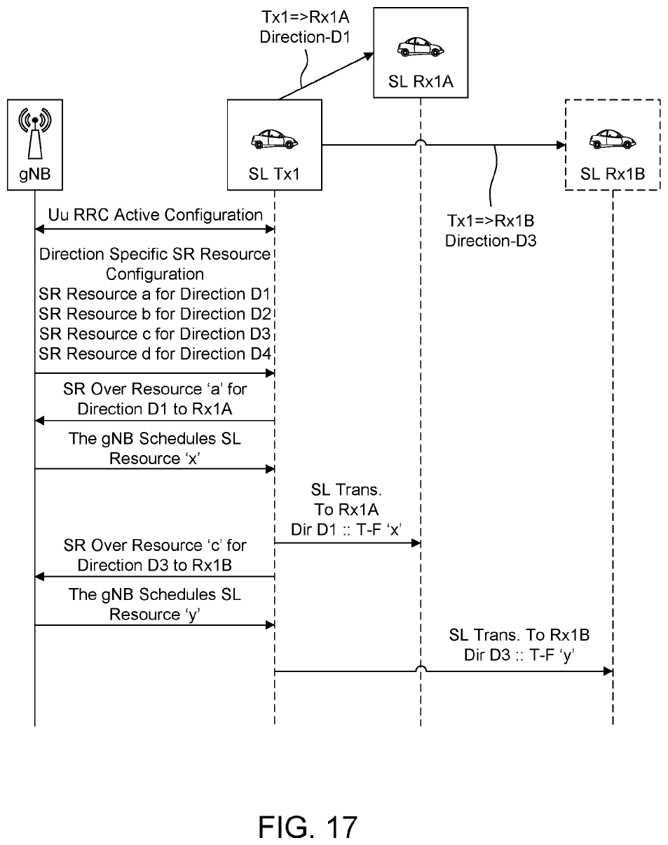

Message exchanges for this innovation with respect to FIG. 17 are discussed in the following. A SL Tx WTRU (SL Tx1) receives a set of SR resource configurations which in this disclosure are multiple direction specific SR resources. The mapping of each SR resource set to a direction and Tx-location (or zone) is also part of the configuration. As an example (not shown in FIG. 17), SR resource ‘a’ for transmissions in a quadrant 1, SR resource ‘b’ for transmissions in a quadrant 2, and so on. More elaborate configurations and mappings for different angular ranges can be easily obtained at the gNB and communicated to the SL Tx1.

SR resource configurations and mappings may be dependent upon SL Tx WTRU location (or zone) and the direction of transmission; different SR resources may be configured for different zones (it may be similar to location-based resource pool allocation in SL design), and if the SL Tx changes the location (or zone) or/and its direction of transmission, it will use the suitable SR configuration as per the configured mapping.

In FIG. 17, SL Tx1 receives 4 different SR resources for 4 different directions of transmission. When it intends to request a resource to transmit to SL Rx1A, SL Tx1 computes the direction which it estimates as D1. SL Tx1 sends an SR over the SR resource ‘a’ which is mapped to direction D1. Upon receiving an SR from SL Tx1 over the resource ‘a’, the gNB has knowledge of the intended direction of transmission for SL Tx1 for SL Rx1A. The gNB scheduler schedules an appropriate SL resource ‘x’ to SL Tx1 for its transmission in direction D1. The selection of SL resource ‘x’ made by the gNB is appropriate for the direction D1 requested by SL Tx1 for a transmission to SL Rx1A.

At a later stage in time, SL Tx1 intends to transmit to SL Rx1B for which SL Tx1 estimates the intended direction of transmission to be D3. SL Tx1 sends an SR over the SR resource ‘c’ which is mapped to direction D3. Upon receiving an SR from SL Tx1 over the resource ‘c’, the gNB has knowledge of the intended direction of transmission for SL Tx1 for SL Rx1B. The gNB scheduler schedules an appropriate SL resource ‘y’ to SL Tx1 for its transmission in direction D3. The selection of SL resource ‘y’ made by the gNB is appropriate for the direction D3 requested by SL Tx1 for a transmission to SL Rx1B.

The term “directional information” may be used with equal meaning herein to the term “cone of operation”. The “directional information” or “the cone of operation” of a signal which represents the area where this signal can be received with signal energy higher than a threshold. This threshold can be the minimum signal energy which allows decoding this signal or it can be the minimum interference energy which is acceptable when this signal appears as interference at a non-intended receiver. Nevertheless, this threshold can be programmable and different suitable values for this threshold can be agreed upon prior to operation or configured as part of the configuration. This cone of operation is in the shape of a conic beam transmitted by a sidelink device. Thus, the parameters defining this cone of operation include the location of the SL transmitting device, the direction of transmission (or direction of SL receiving device from the transmitting device) and the range of transmission (which is dictated by transmission power and the channel impairments). The cone of operation can be defined more precisely considering the antenna radiation patterns (side lobes and respective antenna gains) and the side information about the terrain/maps/blocking objects etc. In essence, the cone of operation associates an area to a transmitted signal or time-frequency transmission resource where this signal can be received with a non-negligible signal energy, and thus may cause harmful collision if the same time-frequency resource is used by another device within its cone of operation.

With this terminology in place, the scheme for SL configured grant resource allocation includes the gNB configuring multiple SR resource sets to a SL transmitting device where each SR resource set is mapped to a given cone of operation. The determination of cone of operation using suitable parameters such as Tx location, Rx location, transmit beamwidth, transmission power etc., can be part of the configuration. A SL Tx will then send the SL resource request using the appropriate SR resource which is mapped to its estimated cone of operation for an intended transmission.

The embodiment and description of FIG. 17 presented primarily the configuration of SR resource sets mapped to different transmission directions or cones of operation. This idea may be applied verbatim to a SL NACK resource (e.g., uplink resource used/allocated to forward SL HARQ feedback) which is transmitted over Uu interface. More generally, the gNB can configure multiple PUCCH resources mapped to different transmission directions or different cones of operation for a SL Tx. Then a SL Tx will use an appropriate PUCCH resource which matches to its intended direction of transmission or cone of operation according to the configured mapping. This will then allow the SL Tx's transmission of SR and SL HARQ feedback over these direction specific PUCCH resources, and the gNB scheduler will keep getting the fresh estimates of directions of transmission or cones of operation where a SL Tx is intending to transmit.

For dynamic grant-based transmissions, sometimes the gNB may be providing SL grants in a proactive manner if it has the knowledge that a SL Tx may need resources. As such SL grants are provided to a SL Tx WTRU without an explicit request, the direction/cone-of-operation information may be missing. For such proactive grants, the gNB may use the previous direction/cone-of-operation information received from this SL Tx. In a different design, the proactive grants may be sent in a more conservative manner where the same time-frequency resource is not allocated in an immediate vicinity. This makes sense as the gNB will normally send proactive grants when it has surplus of transmission resources compared to the scheduling requests it has received.

The gNB Control of the SL Transmission Power for SL Dynamic Grant where the gNB Provides Multiple Scheduling Request Resource Set

In a compatible design, the gNB having acquired the direction indication may provide a SL Tx an indication of transmit power for its sidelink transmission in addition to the time-frequency resource allocated for its sidelink transmission. The transmit power indication can be the actual transmit power to be used for the SL transmission, or it can be an upper bound which a SL Tx should not cross while transmitting over this SL allocated resource. This indication of SL transmit power can be carried in the downlink message (e.g., DCI) allocating the SL time-frequency resource for the SL Tx.

By providing an indication of SL transmit power, be it the transmission power or the limit on the transmit power, the gNB can control in a fine grain manner the range or cone-of-operation for the SL transmission from a given SL Tx. This allows the gNB scheduler plan the higher occurrence of frequency (T-F resource) reuse in a systematic manner by ensuring that the transmissions from certain SL Txs will stay within certain zones dictated by the SL transmit power indication.

### The gNB Updating the Number of Retransmissions and the SL Transmission Power

In a compatible design, the gNB may provide the indication of the SL transmission power and the number of re-transmissions for the SL transport block. The initial number of re-transmissions may be a number acquired as part of the SL configuration, or it can be a specific number of re-transmissions requested by a SL Tx to reach a certain level of QoS target. The benefit for the update of the number of re-transmissions compared to the initial value is that the gNB may decide to limit the SL transmission power to a certain degree to enable higher occurrence of frequency resource reuse without degrading the transmissions carried over the same time-frequency resource. The limits imposed on the SL transmit power reduce the interference with the neighboring transmissions but may also degrade the detection quality at the desired recipients. To compensate, the gNB may schedule additional re-transmission(s) for the same transport block which ensures higher reliability of the transport block at the target recipient(s).

By providing an indication of SL transmit power and the number of re-transmissions, the gNB can control the trade-off of transmission power and number of re-transmissions where a given choice of transmission power lets the gNB choose appropriate time-frequency resource reuse for the SL resources. Downlink DCI which provides the SL allocated resource to a SL Tx may need to be appropriately updated by introducing the indication of transmit power and the number of re-transmission resources.

### The gNB Scheduling Multiple Direction Specific SL Transmission Resources

In a design compatible to the previous proposals, the gNB, having received the scheduling request from a SL Tx over a direction specific SR/PUCCH resource, can provide multiple SL resources to a SL Tx. Multiple SL resources which are associated to different SL transmission directions. They can incorporate the change of direction of transmission due to various factors e.g., the mobility of SL Tx, SL Rx and the change of location between the time while a scheduling request was made to the time of the actual SL transmission etc. The number of direction specific resources provided by the gNB can be part of the configuration or pre-configuration. The mapping of different SL transmission resources to different transmit directions can be part of the specification or can be part of pre-configuration. Additional resources may be associated to the directions which are neighboring to the direction indicated by the SL Tx to the gNB. In one specific example, the gNB can provide three direction specific resources as part of SL grant. One resource can be associated to the direction indicated by the SL Tx. The other two resources could be associated to two neighboring directions on either side of the indicated direction.

In a variation of this design, the number of direction specific resources can be indicated dynamically by the gNB. The gNB can consider the user mobility and the network dynamics to provide a given number of direction specific resources. The mapping of direction specific resources to suitable directions, neighboring to the SL Tx intended direction of transmission, can be part of the configuration or it can be indicated as part of dynamic signaling from the gNB to a SL Tx.

### Applicability to Multicast or Groupcast Sidelink Transmissions Using Direction Specific SL Transmission Resources

In a variation, the proposed disclosure can be applied to multicast or groupcast sidelink transmissions. For sidelink systems operating at very high occurrences of reuse of T-F resources, a SL Tx may not be capable of transmitting in multiple directions where it should transmit for a groupcast transmission. This may be the result of users spread in various directions which form a group of communicating sidelink devices. This may imply that a SL Tx will perform multiple sidelink transmissions in different directions in a TDMA manner. In this regard, a SL Tx will decide the directions it should transmit to achieve a groupcast transmission. The gNB will provide the configuration of SR/PUCCH resources with their mapping to different groupcast directions. In one example, dedicated SR/PUCCH resources may be configured to request for multicast/groupcast SL transmission resources. In another example, common SR/PUCCH resources may be configured for unicast and multicast/groupcast transmission resources, and specific indication (e.g., specific one-bit field) may be configured to indicate whether the request is for unicast or multicast/groupcast SL transmission. The allocation of SR/PUCCH resources for groupcast/multicast SL transmissions may require special signaling and quantization for direction indication suitable to group specific aspects and multiple directions which might need to be indicated. To contain the overhead of the multiple directions specific SR/PUCCH resources for a groupcast SL transmission, the design may favor the quantization of multiple groupcast transmission directions to a wide/coarse direction (e.g., covering the multiple directions associated with the groupcast transmissions) for which SR/PUCCH resources are provided by the gNB. When the gNB receives a scheduling request through a specific SR/PUCCH resource, the gNB can provide the allocation of time-frequency resources which allow covering the directions of the groupcast transmissions. In one example, the WTRU may indicate a wide direction with an indication of number of transmissions/receivers. The gNB may use the information of number of transmissions/receivers to allocate the enough number of resources. The gNB can provide multiple transmission resources for SL Tx transmissions in different directions such that the groupcast transmission is achieved in practice as a combination of multiple TDMA transmissions. This allows the gNB scheduler flexibility to achieve higher T-F resource reuse. The association of transmission resources to different transmission directions can be part of the pre-configuration, e.g., in a special sequence, or it could be provided as part of the dynamic grant signaling transmitted by the gNB.

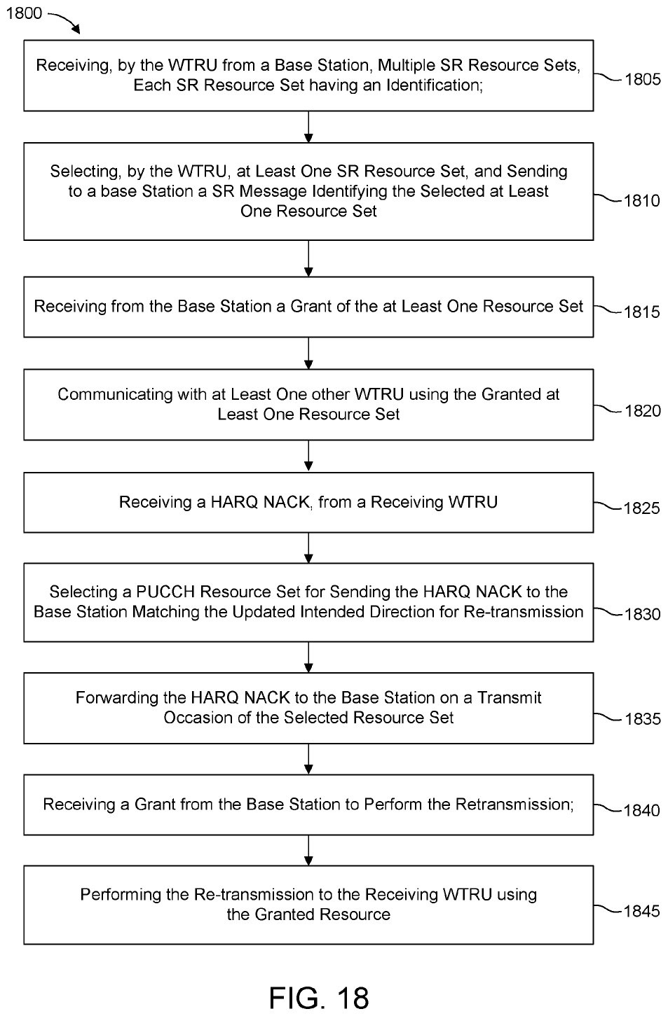

FIG. 18 depicts a flow diagram of a method 1800 to use multiple direction specific SL transmission resources by a WTRU. The method 1800 is performed by a WTRU in communication with a base station, such as a gNB to acquire SL transmission resources with which to communicate with other WTRUs. At 1805, the WTRU receives from a base station, multiple SR resource sets. In a more general setting, these can be PUCCH resource sets. Each SR resource set having an identification and an indication of SL transmission direction (cone-of-operation) for which this SR resource set should be used by a SL Tx. At 1810, the WTRU selects at least one SR resource set previously provided by the base station which matches its intended direction of SL transmission. The WTRU sends to a base station a SR message identifying at lease one selected resource set. The selection by the WTRU can be one resource set or multiple resource sets depending on whether the WTRU intends to communicate with one receiving WTRU using a unicast transmission or communicate with multiple other receiving WTRUs using multicast transmission. At 1815, the WTRU receives from the base station a grant of the at least one resource for its SL transmission. At 1820, the WTRU can communicate with at least one other (receiving) WTRU using the granted at least one resource set. At this step, the SR and the corresponding grant have been accomplished to allow communication with at least one WTRU where the base station has provided a dynamic grant of a T-F resource based on a WTRU selection of an appropriate SR resource. In a further example, further described below, a hybrid automatic repeat-request (HARQ) based re-transmission may be needed which is outlined in FIG. 18 beginning at 1825.

At 1825, if a HARQ negative acknowledgement (HARQ NACK) is received from a receiving WTRU, then at 1830, the Tx WTRU selects a PUCCH resource set to send the received HARQ NACK to the base station. The selection is performed on the PUCCH resource sets that the Tx WTRU has previously received from the base station. The transmitting WTRU chooses the PUCCH resource which matches the updated direction of transmission for re-transmission toward the receiving WTRU. At 1835, the Tx WTRU forwards to the base station the HARQ NACK on a transmit occasion of the selected PUCCH resource set. At 1840, the Tx WTRU receives from the base station a grant to perform the re-transmission. At 1845 the Tx WTRU performs the re-transmission to the receiving WTRU using the granted resource.

In the above method, receiving SR resource sets may include receiving an identification of each SR resource set and an associated transmission direction. The associated transmission direction is a cone of operation which includes any of WTRU location, receiving WTRU location, SL transmission direction, transmission power, and transmission beamwidth. In the above method, selecting at least one SR resource set may include selecting one SR resource set for a unicast transmission or selecting one SR resource sets for a multicast or groupcast operation/transmission. In the method of FIG. 18, sending a SR identifying the selected at least one resource set may include sending the SR using a transmission opportunity of the at least one SR resource sets. Also, receiving a grant of the at least one resource set may include receiving a grant of multiple time-frequency resources and an indication of transmission direction of each of the multiple time-frequency resources for use in sidelink transmissions to multiple other WTRUs. In the method of FIG. 18, communicating with at least one other WTRU using the granted at least one resource set may include the Tx WTRU transmitting to one other WTRU (a Rx WTRU) using a unicast transmission on a granted resource set or the WTRU transmitting to multiple other WTRUs using multiple ones of the granted at least one resource sets in a multicast transmission.

### Example Embodiment—Unicast Transmission Using Direction Specific SL Transmission Resources

An example embodiment describing a method performed by a SL Tx to request dynamic-grant resource allocation for a unicast SL transmission from the gNB may be as follows. A SL Tx receiving a configuration from the gNB containing multiple scheduling request resource sets each with a separate identification where a mapping is provided as part of the configuration, the mapping associating each SR resource set with a cone of operation for this SL Tx, the SL Tx WTRU may take the following actions:
Selecting a suitable SR resource set as a function of its current estimate of its cone of operation for its intended transmission;
Transmitting an SR on a suitable occasion of the selected SR resource set;
Receiving SL scheduling grant from the gNB;
Performing SL transmission to a SL Rx using the gNB scheduled SL resource.

The above example embodiment may include:
The SL Tx tracks its cone of operation which in turn may include any combination of the following parameters: Tx location, Rx location, transmission direction, transmission power, transmission beamwidth.
The cone of operation is determined using the configured formula.
The cone of operation is determined using the known formula where some of the parameters may be configured as part of configured grant configuration.
The SL Tx may track and update the direction of transmission from the measurement reports received from the SL Rx.
The gNB can provide an indication of SL transmission power. This SL transmission power can be the actual power with which SL Tx should transmit or it can be the upper limit which a SL Tx should not cross while transmitting over the allocated SL transmission resource.
The gNB can provide an indication of SL transmission power and the number of re-transmissions. This SL transmission power can be the actual power with which SL Tx should transmit or it can be the upper limit which a SL Tx should not cross while transmitting over the allocated SL transmission resource. The number of re-transmissions can be different from the one requested by SL Tx or understood from the pre-configuration.
The gNB can provide multiple direction specific dynamic grant resources where SL Tx will choose the suitable resource according to the most recent direction/cone-of-operation estimate available prior to the actual transmission.
The number of multiple direction specific dynamic grant resources can be part of the pre-configuration.
The number of multiple direction specific dynamic grant resources can be indicated dynamically as part of the SL grant.
The mapping of multiple direction specific resources to indicated direction and the neighboring directions can be part of the pre-configuration.
The mapping of multiple direction specific resources to indicated direction and the neighboring directions can be indicated dynamically as part of the dynamic grant signaling.

### Example Embodiment—Unicast Re-transmission Using Direction Specific SL Transmission Resources

An example embodiment describing a method performed by a SL Tx to request dynamic-grant resource allocation for a unicast SL transmission from the gNB may be as follows. A SL Tx receiving a configuration from the gNB containing multiple SR and PUCCH resource sets where each SR/PUCCH resource set with a separate identification where a mapping is provided as part of the configuration, the mapping associating each PUCCH resource set with a cone of operation for this SL Tx, the SL Tx WTRU may take the following actions:
Selecting a suitable SR resource set as a function of its current estimate of its cone of operation for its intended transmission;
Transmitting an SR on a suitable occasion of the selected SR resource set;
Receiving SL scheduling grant from the gNB;
Performing SL transmission to a SL Rx using the gNB scheduled SL resource;
On receiving a HARQ NACK from the SL Rx, selecting a suitable PUCCH resource set as a function of its current estimate of its cone of operation for its intended re-transmission to the SL Rx, and forwarding the HARQ NACK on a suitable occasion of the selected PUCCH resource set;
Receiving SL scheduling grant from the gNB to perform the re-transmission to the SL Rx; and
Performing SL re-transmission to the SL Rx using the gNB scheduled SL resource.

The above example embodiment may include:
The SL Tx tracks its cone of operation which in turn may include any combination of the following parameters: Tx location, Rx location, transmission direction, transmission power, transmission beamwidth.
The cone of operation is determined using the configured formula.
The cone of operation is determined using the known formula where some of the parameters may be configured as part of configured grant configuration.
The SL Tx may track and update the direction of transmission from the measurement reports received from the SL Rx.
The gNB can provide an indication of SL transmission power. This SL transmission power can be the actual power with which SL Tx should transmit or it can be the upper limit which a SL Tx should not cross while transmitting over the allocated SL transmission resource.
The gNB can provide an indication of SL transmission power and the number of re-transmissions. This SL transmission power can be the actual power with which SL Tx should transmit or it can be the upper limit which a SL Tx should not cross while transmitting over the allocated SL transmission resource. The number of re-transmissions can be different from the one requested by SL Tx or understood from the pre-configuration.
The gNB can provide multiple direction specific dynamic grant resources where SL Tx will choose the suitable resource according to the most recent direction/cone-of-operation estimate available prior to the actual transmission.
The number of multiple direction specific dynamic grant resources can be part of the pre-configuration.
The number of multiple direction specific dynamic grant resources can be indicated dynamically as part of the SL grant.
The mapping of multiple direction specific resources to indicated direction and the neighboring directions can be part of the pre-configuration.
The mapping of multiple direction specific resources to indicated direction and the neighboring directions can be indicated dynamically as part of the dynamic grant signaling.

### Example Embodiment—Multicast/Groupcast Transmission Using Direction Specific SL Transmission Resources

An example embodiment describing a method performed by a SL Tx to request dynamic-grant resource allocation from the gNB for its multicast/groupcast transmission may be as follows. A SL Tx receiving a configuration from the gNB containing multiple SR/PUCCH resource sets to request the resources for multicast/groupcast SL transmissions, where each SR/PUCCH resource set is with a separate identification where a mapping with a direction (angular area) is provided as part of the configuration, the SL Tx WTRU may take the following actions:
Selecting a suitable SR resource set as a function of its current estimate of direction covering the groupcast SL transmissions need to be performed;
Transmitting an SR on a suitable occasion of the selected SR resource set;
Receiving multiple time-frequency resources from the gNB and an indication for mapping of multiple SL resources with the directions (within the requested angular area) to which these time-frequency resources can be used for the SL transmission; and
SL Tx performing transmissions to its multiple SL Rx(s) using the allocated time-frequency resources in the associated directions.

The above example embodiment may include:
Common SR resources configured for unicast and multicast/groupcast transmission resources may be used with a specific indication (e.g., specific one bit field) indicating that the request is for a multicast/groupcast SL transmission.
The gNB can provide an indication of SL transmission power for each of the groupcast SL transmissions. This SL transmission power can be the actual power with which SL Tx should transmit or it can be the upper limit which a SL Tx should not cross while transmitting over the allocated SL transmission resource.
The gNB can provide an indication of SL transmission power and the number of re-transmissions for each of the groupcast transmissions. This SL transmission power can be the actual power with which SL Tx should transmit or it can be the upper limit which a SL Tx should not cross while transmitting over the allocated SL transmission resource. The number of re-transmissions can be different from the one requested by SL Tx or understood from the pre-configuration.
The direction indication for groupcast transmission can be a combination of multiple narrow directions and wide directions.
The mapping of multiple SL resources allocated by the gNB for a groupcast transmission to indicated directions is part of the pre-configuration.

### Example Embodiment—SL Periodic Resources and Uu PUCCH Resources Associated to SL Directions

An example embodiment describing a method performed by a SL Tx to request periodic SL resource allocation from the gNB for its SL transmission may be as follows. A SL Tx requesting and receiving a configuration from the gNB containing multiple direction specific periodic resource where the configuration also provides the association of each periodic SL resource to a SL directional information. This configuration was explained with FIG. 12. Not shown in FIG. 12, the configuration may include multiple PUCCH resources over Uulink from the Tx WTRU to the gNB to provide HARQ ACK-NACK as received over the SL. The PUCCH resources are associated to the SL directional information in very much the same way as SL periodic resources. The exact association of PUCCH resources to SL directional information may be different compared to the association of SL resources. If the Tx WTRU is configured to report SL HARQ ACK-NACK to the gNB, Tx WTRU will choose the PUCCH resource associated to its current estimate of SL directional information and report HARQ ACK-NACK to the gNB. This provides an indication to the gNB of the current SL directional information of the Tx WTRU. The advantage is that if the gNB decides to send a dynamic grant for SL re-transmission, thanks to the available directional information of the Tx WTRU, the gNB may choose a suitable SL resource achieving higher frequency reuse and avoiding interference.

Referring back to FIG. 12, additional steps may further include receiving, in the configuration information received by the Tx WTRU, multiple direction specific uplink resources, such as PUCCH, useful for transmission to a BS. The multiple direction specific uplink resources are associated with different directional information for SL transmission. In a SL communication, a Tx receives a HARQ-NACK from the Rx WTRU. The Tx WTRU can send to the BS an indication of the received HARQ-NACK over a Uu link using an uplink resource associated with an updated estimate of directional information. The Tx WTRU then receives from the BS on the Uu link, an indication of a SL resource to perform data re-transmission. The Tx WTRU then can perform data re-transmission over SL to the Rx WTRU. In one aspect, receiving from the BS an indication to perform data re-transmission to the Rx WTRU over SL can be one of a periodic resource grant or a dynamic resource grant.

### Example Embodiment—Tx WTRU Operation Using Direction Specific SL Transmission Resources

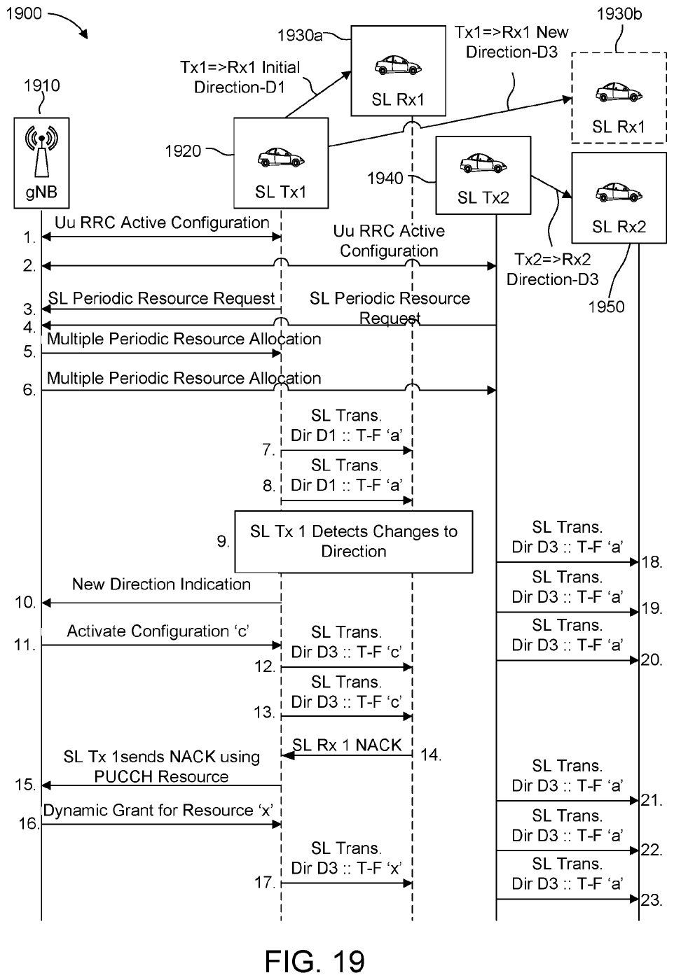

FIG. 19 depicts a signal diagram 1900 of a Tx WTRU operation using direction specific information to use SL T-F resources. The signal diagram includes a Base Station 1910, such as a gNB, a sidelink transmitting WTRU (SL Tx1) 1920, a sidelink receiving WTRU (SL Rx1) at a first location 1930a and at a second location 1930b, a sidelink transmitting WTRU (SL Tx2) 1940 and a sidelink receiving WTRU (SL Rx2) 1950. SL Tx1 transmits to SL Rx 1 1930 with an initial “directional information” of D1. The configuration may set the details of the directional information. SL Tx2 1940 transmits to SL Rx2 1950 with a direction of D3. At item 1, a Uu RRC active configuration is established between the BS 1910 and the SL Tx1 1920. At item 2 similar configuration is active between the BS 1910 and SL Tx2 1940. At item 3, SL Tx1 has a SL periodic resource request and at item 4, SL Tx2 has a SL periodic resource request. At items 5 and 6, the base station 1910 provides the configurations to the SL transmitters SL Tx1 and SL Tx2. This configuration comprises of SL configurations for multiple periodic resource allocations to the transmitting WTRUs respectively. The base station also provides an indication of active resource configuration among the configured configurations. In addition to SL resource configurations, the configuration also comprises of the direction specific PUCCH resources over the Uu. These PUCCH resources over Uu interface between SL Txs and the base station can be used by the SL Txs to provide the directional information to the base station and to convey the SL NACK received by their respective SL Rxs. At items 7 and 8, SL transmissions occur between SL Tx1 and SL Rx1 while SL Rx1 is at a first location 1930a. These SL transmissions occur in direction D1 using T-F resource allocation ‘a’ provided by the BS 1910.

It is noted that SL transmissions 18, 19, and 20 between SL Tx2 and SL Rx2 also use T-F resource allocation ‘a’, but since the direction of transmission is different between SL Tx1 and SL Tx2, (direction D1 versus D3) then there is no collision of service between the pairs of transmitter and receiver WTRUs.

At box 9, the SL Tx1 WTRU detects a change in the direction of its receiver SL Rx1. In the example, SL Rx1 is moving from a location depicted as 1930a to a location depicted as 1930b. Upon detecting or estimating/predicting the change in direction, SL Tx1 sends a new direction indication item 10 to the BS. In this instance, it is assumed that the direction of SL Rx1 has changed or is precited to change from direction D1 to D3. Direction D3 is already being used by SL Tx2 to transmit to SL Rx2 using T-F resource ‘a’. Thus, a collision may occur if SL Tx1 continues to use T-F resource ‘a’ for direction D3. At item 11, the BS provides SL TX1 with a message to activate a configuration ‘c’ T-F resource. At items 12 and 13, the SL Tx1 WTRU communicates with SL Rx1 using T-F resource ‘c’ in direction D3. There is no collision of transmissions between SL Tx1 and SL Tx2 while both have active directional information in direction D3 because different T-F resources are used by the two transmitting WTRUs.

At item 14, a NACK from SL Rx1 is received by SL Tx1. This NACK could be an indication of a failed decoding of a transmission over T-F resource ‘c’ used by SL Tx1 to communicate with SL Rx1. At item 15, the SL Tx1 sends an indication of the NACK using a PUCCH resource to the BS 1910. The BS responds to the SL TX1 by providing a dynamic resource grant for T-F resource ‘x’. Thereafter, the SL Tx1 uses the T-F resource ‘x’ to communicate in direction D3 to the SL Rx1. Meanwhile, as depicted in items 21, 22, and 23, the communication between SL Tx2 and its receiver SL Rx 2 has not changed. The SL Tx2 is transmitting in direct D3 using T-F resource ‘a’. In addition to providing a dynamic grant in response to NACK reporting by SL Tx1 at item 15, the base station can also change the periodic resource configuration. In that case, the base station will provide an indication of change of configuration to the SL Tx1 to activate a different SL periodic configuration.

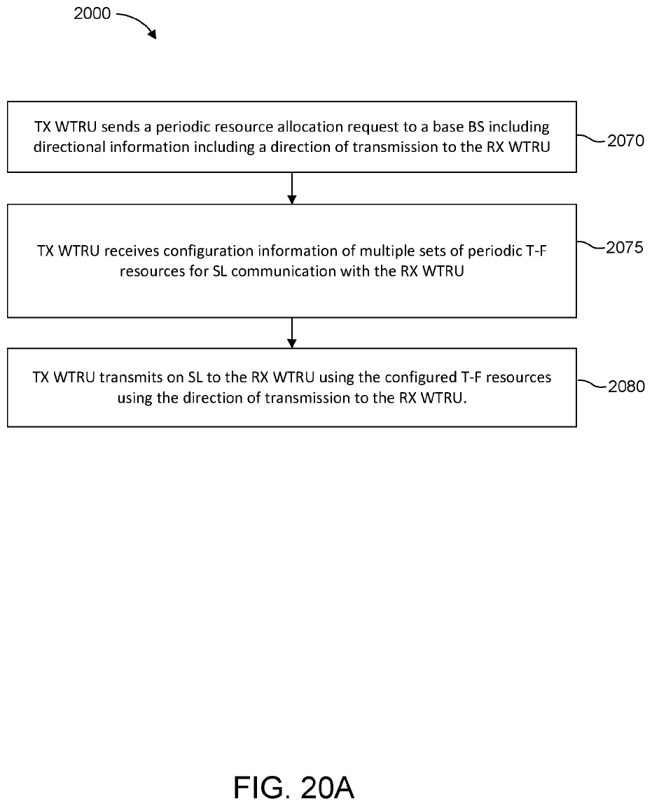

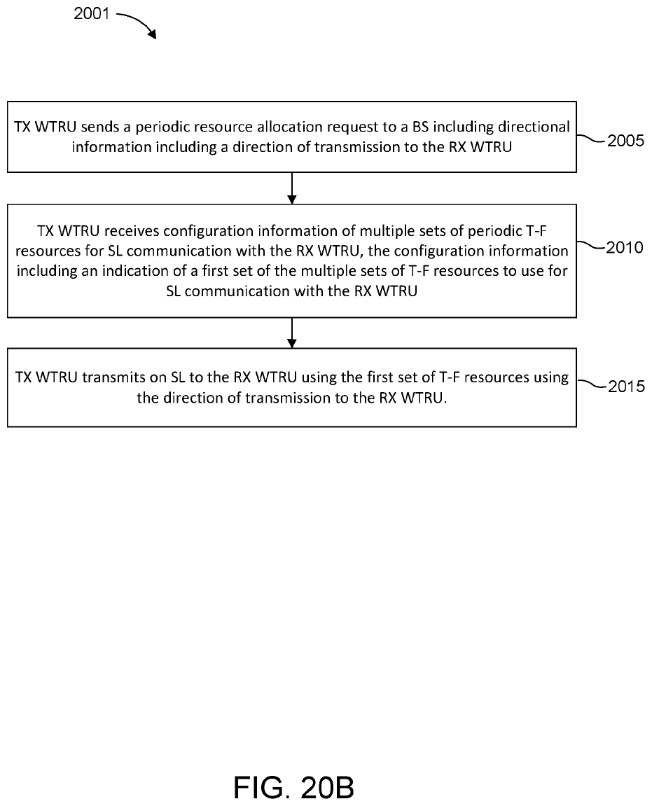

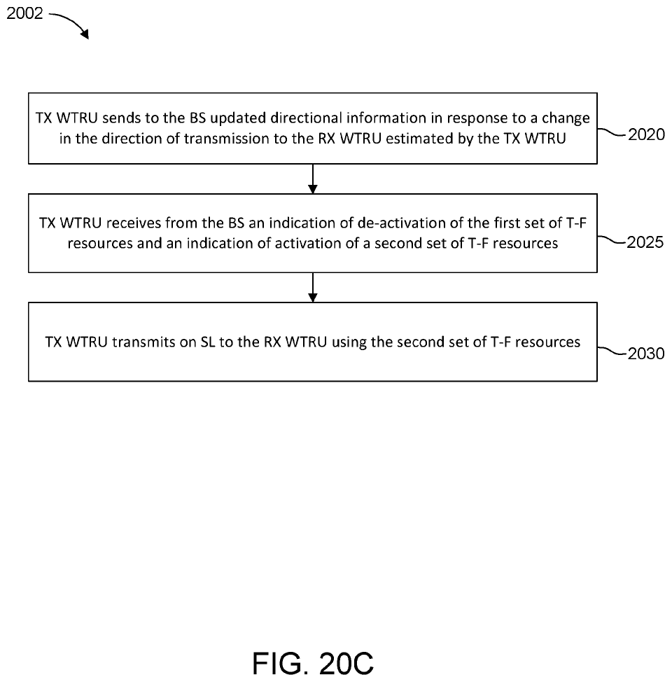

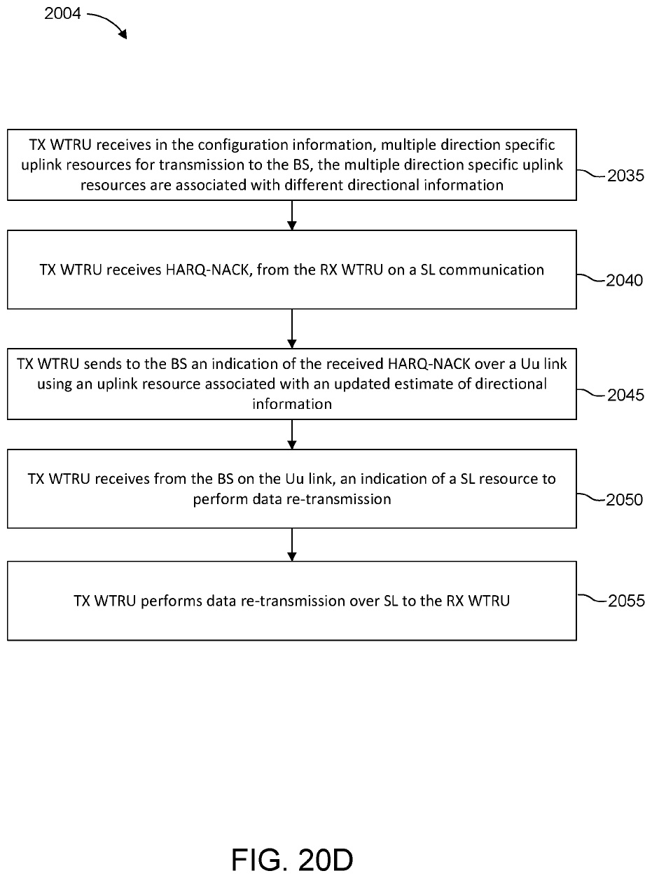

FIG. 20A depicts an example method 2000 of a Tx WTRU using a periodic T-F resources to communicate directionally over the SL with a Rx WTRU in an environment of multiple WTRUs. At 2070, a Tx WTRU sends a periodic resource allocation request to a base station (BS), for example a gNB, including directional information, such as a cone of operation, including a direction of transmission to the Rx WTRU. In one example, sending a periodic resource allocation request to a BS including directional information may include sending directional information which associates an area to a transmitted signal using a T-F resource. In another example, the directional information may contain any one or more of a Tx WTRU location, Rx WTRU location, transmit beamwidth, transmission power and/or a range of transmission to be used in a set of periodic T-F resources for SL communication.

At 2075, the Tx WTRU receives configuration information of multiple sets of periodic T-F resources for SL communication with the Rx WTRU. Optionally, the configuration information may include an indication of a first set of the multiple sets of T-F resources to use for SL communication with the Rx WTRU. In another design, the Tx WTRU may select for itself the first set of T-F resources as a function of directional information to its Rx WTRU. Using this first set of T-F resources, the Tx WTRU transmits on SL to the Rx WTRU at 2080. The transmission uses the direction of transmission to the Rx WTRU.

FIG. 20B depicts an example method 2001 of a Tx WTRU using a periodic T-F resources to communicate directionally over the SL with a Rx WTRU in an environment of multiple WTRUs. At 2005, a Tx WTRU sends a periodic resource allocation request to a base station (BS), for example a gNB, including directional information, such as a cone of operation, including a direction of transmission to the Rx WTRU. In one example, sending a periodic resource allocation request to a BS including directional information may include sending directional information which associates an area to a transmitted signal using a T-F resource. In another example, the directional information may contain any one or more of a Tx WTRU location, Rx WTRU location, transmit beamwidth, transmission power and/or a range of transmission to be used in a set of periodic T-F resources for SL communication.

At 2010, the Tx WTRU receives configuration information of multiple sets of periodic T-F resources for SL communication with the Rx WTRU. The configuration information may include an indication of a first set of the multiple sets of T-F resources to use for SL communication with the Rx WTRU. Using this first set of T-F resources, the Tx WTRU transmits on SL to the Rx WTRU. The transmission uses the direction of transmission to the Rx WTRU.

The method 2001 of FIG. 20B is an example of directional transmission coordinated by both the BS and the Tx WTRU to communicate on SL with the Rx WTRU in a crowded environment which includes multiple Rx WTRUs within transmission range of the multiple Rx WTRUs.

The method 2001 of FIG. 20B may be further followed by the method 2002 of FIG. 20C. In FIG. 20C at 2020 the Tx WTRU sends to the BS updated directional information in response to a change in the direction of transmission to the Rx WTRU estimated by the TX WTRU. In this instance the Tx WTRU has received an indication that the Rx WTRU is changing direction and updated directional information is needed to assess whether a different T-F resource should be used for the SL communication with the Rx WTRU. In one example, sending to the BS the updated directional information is based on an estimate by the TX WTRU that a threshold of the current directional information will be exceeded.

At 2025, after the BS, such as a gNB, determines that a different T-F resource is needed to accommodate the movement of the Rx WTRU, the Tx WTRU receives from the BS an indication of de-activation of the first set of T-F resources and an indication of activation of a second set of T-F resources for the Tx WTRU to use for the communication to the Rx WTRU. At 2030, the Tx WTRU uses the second set of T-F resources received from the BS to transmit on SL to the Rx WTRU.

The method 2001 of FIG. 20B may be followed by the example method 2004 of FIG. 20D where the Tx WTRU and the BS accommodate a negative acknowledgement from the Rx WTRU. In FIG. 20D at 2035, the Tx WTRU receives, in the configuration information that it receives from the BS, multiple direction specific uplink resources for transmission to the BS. The multiple direction specific uplink resources are associated with different directional information. This provides the Tx WTRU with information of different directional options from which to choose for an estimation if the Tx WTRU should need different directional information to use to communicate with the Rx WTRU.

At 2040, the Tx WTRU receives a HARQ-NACK, from the RX WTRU while performing a SL communication with that Rx WTRU. Having received the HARQ-NACK, the Tx WTRU, at 2045, sends to the BS an indication of the received HARQ-NACK over a Uu link to the BS including a possible uplink resource associated with an updated estimate of directional information that the Tx WTRU has made. At 2050 in FIG. 20D, the Tx WTRU receives from the BS on the Uu link, an indication of a SL resource to perform a data re-transmission to the Rx WTRU. In one example, the Tx WTRU receives from the base station an indication to perform data re-transmission to the RX WTRU over SL according to one of a periodic resource grant which could indicate one of the prior configured periodic SL resource configurations or a dynamic resource grant. Having the updated resource for a directional communication with the Rx WTRU on SL, the TX WTRU performs the data re-transmission over SL to the RX WTRU at 2055. In response to receiving a NACK from the SL Tx over a direction specific PUCCH resource at item 2045, at item 2050 the base station can provide a dynamic grant for SL re-transmission or indicate an updated SL periodic resource configuration to be used for re-transmission and the subsequent transmissions. The base station can provide both a dynamic grant for re-transmission and an indication of change of periodic SL configuration to the SL Tx at item 2050. This could be useful in the case when a fast re-transmission may be needed compared to what a periodic resource configuration can accommodate.

As discussed above, the method of FIG. 20B may be followed by the method of FIG. 20C. The method of FIG. 20C may be followed by the method of FIG. 20D. Also contemplated is that the methods of FIGS. 20B, 20C, and 20D may be concatenated. Also contemplated is the order of FIGS. 20C and 20D following FIG. 20B may be reversed.

Although the features and elements of the present invention are described in the preferred embodiments in particular combinations, each feature or element can be used alone without the other features and elements of the preferred embodiments or in various combinations with or without other features and elements of the present invention. Although the solutions described herein consider New Radio (NR), 5G or LTE, LTE-A specific, it is understood that the solutions described herein are not restricted to this scenario and are applicable to other wireless systems as well.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a W TRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a “specific number of an introduced claim” recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1-14. (canceled)

15. A method performed by a transmitting (Tx) wireless transmit/receive unit (WTRU) performing sidelink (SL) communications with a receiving (Rx) WTRU, the method comprising:
sending a periodic SL resource allocation request to a base station (BS);
receiving configuration information from the BS of multiple sets of direction specific periodic time-frequency (T-F) resources for SL communication with the Rx WTRU, wherein the multiple sets of direction specific periodic resources are associated with different directional information for SL transmission;
determining a first direction of transmission to the Rx WTRU and selecting a first set of periodic T-F resources associated with the first direction of transmission to the Rx WTRU;
transmitting on SL to the Rx WTRU using the first set of periodic T-F resources using the first direction of transmission to the Rx WTRU, determining, by the Tx WTRU, a second direction of transmission to the Rx WTRU;
de-activating of the first set of periodic T-F resources;
activating a second set of periodic T-F resources associated with the second direction of transmission to the Rx WTRU; and
transmitting on SL to the Rx WTRU using the second set of T-F resources.

16. The method of claim 15, wherein receiving configuration information from the BS of multiple sets of direction specific periodic T-F resources comprises receiving configuration information of multiple sets of slots and sub-channels that are assigned to the Tx WTRU.

17. The method of claim 5 wherein determining, by the Tx WTRU, a second direction of transmission to the Rx WTRU comprises determining that a threshold of current directional information will be exceeded.

18. The method of claim 15 further comprising:
sending to the BS an indication of the activated second set of periodic T-F resources.

19. The method of claim 15, wherein sending a periodic resource allocation request to a BS includes sending a transmission direction from Tx WTRU to Rx WTRU.

20. The method of claim 15 wherein sending a periodic resource allocation request to a BS includes sending directional information which associates an area to a transmitted signal using a T-F resource.

21. The method of claim 20, wherein the directional information comprises any one or more of a Tx WTRU location, Rx WTRU location, transmit beamwidth, transmission power or range of transmission to be used in a set of periodic T-F resources for SL communication.

22. The method of claim 15 further comprising:
receiving, in the configuration information, multiple direction specific uplink resources for transmission to the BS, wherein the multiple direction specific uplink resources are associated with different directional information for SL transmission;
receiving a hybrid automatic repeat request (HARQ) negative acknowledgement (NACK) from the Rx WTRU on a SL communication;
sending to the BS an indication of the HARQ-NACK over a Uu link using an uplink resource associated with an updated estimate of directional information;
receiving from the BS on the Uu link, an indication of a SL resource to perform data re-transmission; and
performing data re-transmission over SL to the Rx WTRU.

23. The method of claim 22, wherein receiving from the BS an indication to perform data re-transmission to the Rx WTRU over SL is one of a periodic resource grant or a dynamic resource grant.

24. (canceled)

25. A transmit (Tx) wireless transmit/receive unit (WTRU) performing sidelink (SL) communications with a receiving (Rx) WTRU, the Tx WTRU comprising circuitry, including a transmitter, a receiver, a processor, and memory, the Tx WTRU configured to:
send a periodic resource allocation request to a base station (BS);
receive configuration information from the BS of multiple sets of direction specific periodic time-frequency (T-F) resources for SL communication with the Rx WTRU, wherein the multiple sets of direction specific periodic resources are associated with different directional information for SL transmission;
determine a first direction of transmission to the Rx WTRU, and select a first set of periodic T-F resources associated with the first direction of transmission to the Rx WTRU;
transmit on SL to the Rx WTRU using the first set of periodic T-F resources using the first direction of transmission to the Rx WTRU;
determine, by the Tx WTRU, a second direction of transmission to the Rx WTRU;
de-activate the first set of periodic T-F resources;
activate a second set of periodic T-F resources associated with the second direction of transmission to the Rx WTRU; and
transmit on SL to the Rx WTRU using the second set of T-F resources.

26. The Tx WTRU of claim 25, wherein the Tx WTRU receives the multiple sets of direction specific periodic T-F resources comprising multiple sets of slots and sub-channels that are assigned to the Tx WTRU.

27. The Tx WTRU of claim 25, wherein the Tx WTRU determines the second direction of transmission to the Rx WTRU via determining that a threshold of current directional information will be exceeded.

28. The Tx WTRU of claim 25 further configured to:
send to the BS an indication of the activated second set of periodic T-F resources.

29. The Tx WTRU of claim 25, wherein the Tx WTRU sends a periodic resource allocation request to a BS that includes a transmission direction indicating a direction from the Tx WTRU to the Rx WTRU.

30. The Tx WTRU of claim 25, wherein the Tx WTRU sends a periodic resource allocation request to a BS including directional information which associates an area to a transmitted signal using a T-F resource.

31. The Tx WTRU of claim 25, wherein the directional information comprises any one or more of a Tx WTRU location, Rx WTRU location, transmit beamwidth, transmission power or range of transmission to be used in a set of periodic T-F resources for SL communication.

32. The Tx WTRU of claim 25, further configured to:
receive, in the configuration information, multiple direction specific uplink resources for transmission to the BS, wherein the multiple direction specific uplink resources are associated with different directional information for SL transmission;
receive a hybrid automatic repeat request (HARQ) negative acknowledgement (NACK) from the Rx WTRU on a SL communication;
send to the BS an indication of the HARQ-NACK over a Uu link using an uplink resource associated with an updated estimate of directional information;
receive from the BS on the Uu link, an indication of a SL resource to perform data re-transmission; and
perform data re-transmission over SL to the Rx WTRU.

33. The Tx WTRU of claim 26, wherein receiving from the BS an indication to perform data re-transmission to the Rx WTRU over SL is one of a periodic resource grant or a dynamic resource grant.

34. A non-transient computer-readable storage medium comprising instructions, which when executed by a computer, cause the computer to carry out a method performed by a transmitting (Tx) wireless transmit/receive unit (WTRU) performing sidelink (SL) communications with a receiving (Rx) WTRU, the method comprising:
sending a periodic SL resource allocation request to a base station (BS);
receiving configuration information from the BS of multiple sets of direction specific periodic time-frequency (T-F) resources for SL communication with the Rx WTRU, wherein the multiple sets of direction specific periodic resources are associated with different directional information for SL transmission;
determining a first direction of transmission to the Rx WTRU, and selecting a first set of periodic T-F resources associated with the first direction of transmission to the Rx WTRU;
transmitting on SL to the Rx WTRU using the first set of periodic T-F resources using the first direction of transmission to the Rx WTRU;
determining, by the Tx WTRU, a second direction of transmission to the Rx WTRU;
de-activating of the first set of periodic T-F resources;
activating a second set of periodic T-F resources associated with the second direction of transmission to the Rx WTRU; and
transmitting on SL to the Rx WTRU using the second set of T-F resources.

35. The non-transient computer-readable storage medium of claim 34 further comprising:
sending to the BS an indication of the activated second set of periodic T-F resources.
